(19) United States
(12) Patent Application Publication
(10) Pub. No.: US 2014/0340545 A1
(43) Pub. Date: Nov. 20, 2014

(54) ZOOM LENS SYSTEM, IMAGING DEVICE AND CAMERA

(71) Applicant: Panasonic Corporation, Osaka (JP)

(72) Inventors: Yusuke YONETANI, Hyogo (JP); Yoshiaki KURIOKA, Osaka (JP)

(21) Appl. No.: 14/447,631

(22) Filed: Jul. 31, 2014

Related U.S. Application Data
(63) Continuation of application No. PCT/JP2012/008416, filed on Dec. 27, 2012.

(30) Foreign Application Priority Data
Feb. 2, 2012 (JP) 2012-020578

(51) Int. Cl. G02B 15/16

(52) U.S. Cl. CPC G02B 15/161
USPC 348/240.3; 359/683

(57) ABSTRACT

A zoom lens system comprising: a positive first lens unit composed of three or more lens elements; a negative second lens unit; a positive third lens unit; a negative fourth lens unit; and a positive fifth lens unit, wherein at least the first, second and third lens units move with respect to an image surface in zooming, a focusing lens unit, which moves with respect to the image surface in focusing and is composed of one lens element, is provided, and the conditions: 3.2<L_{G3}/(f_{T}×tan(ω_{T})) and 0.3<f_{G1}/f_{T}<0.9 (L_{G3}: optical axial thickness of third lens unit, f_{T}: focal length of zoom lens system at telephoto limit, ω_{T}: half view angle at telephoto limit, f_{G1}: focal length of first lens unit) are satisfied.

### RELATED APPLICATIONS

This application is a Continuation of International Application No. PCT/JP2012/008416, filed on Dec. 27, 2012, which in turn claims the benefit of Japanese Application No. 2012-020578, filed on Feb. 2, 2012, the disclosures of which applications are incorporated by reference herein.

### BACKGROUND

1. Field

The present disclosure relates to zoom lens systems, imaging devices, and cameras.

2. Description of the Related Art

In recent years, development of solid-state image sensors of high pixel density, such as CCDs, CMOSs, is advancing, and digital still cameras and digital video cameras (simply referred to as “digital cameras”, hereinafter) are rapidly spreading which employ imaging devices including imaging optical systems of high optical performance corresponding to the solid-state image sensors of high pixel density. Among the digital cameras of high optical performance, in particular, a compact digital camera including a zoom lens system having a high zoom ratio, which can cover a wide focal length range from a wide-angle region to a high telephoto region by using one digital camera, is strongly desired from a convenience point of view. Further, a zoom lens system having a wide angle range where the photographing field is large is also desired.

Various kinds of zoom lens systems as follows are proposed for the above-mentioned compact digital camera.

Japanese Laid-Open Patent Publication Nos. 2011-123337, 2011-075985, and 2009-282398 each disclose a high magnification zoom lens having a five-unit construction of positive, negative, positive, negative, and positive, and having a zoom ratio of 20 to 30.

Japanese Laid-Open Patent Publications Nos. 2011-033868 and 2010-276655 each disclose a high magnification zoom lens comprising three lens units of positive, negative, and positive, and a subsequent lens unit including at least one lens unit, and having a zoom ratio of 20 to 30.

### SUMMARY

The present disclosure provides a zoom lens system having, as well as a high resolution, a small size and a view angle of 80° or more at a wide-angle limit, which is satisfactorily adaptable for wide-angle image taking, and having a high zoom ratio of 24 or more, and further being a bright zoom lens system which has F-number of 2.8 or so from a wide-angle limit to a telephoto limit. Further, the present disclosure provides an imaging device employing the zoom lens system, and a compact camera employing the imaging device.

The novel concepts disclosed herein were achieved in order to solve the foregoing problems in the related art, and herein is disclosed:

a zoom lens system, in order from an object side to an image side, comprising:

a first lens unit having positive optical power;

a second lens unit having negative optical power;

a third lens unit having positive optical power;

a fourth lens unit having negative optical power; and

a fifth lens unit having positive optical power, wherein

the first lens unit is composed of three or more lens elements,

in zooming from a wide-angle limit to a telephoto limit at a time of image taking, at least the first lens unit, the second lens unit, and the third lens unit move with respect to an image surface,

a focusing lens unit, which moves with respect to the image surface in focusing from an infinity in-focus condition to a close-object in-focus condition, is provided,

the focusing lens unit is composed of one lens element, and

the following conditions (1) and (7) are satisfied:

3.2<L_{G3}/(f_{T}×tan(ω_{T})) (1)

0.3<f_{G1}/f_{T}<0.9 (7)

where

L_{G3} is an optical axial thickness of the third lens unit,

f_{T} is a focal length of the zoom lens system at the telephoto limit,

ω_{T} is a half view angle at the telephoto limit, and

f_{G1} is a focal length of the first lens unit.

The novel concepts disclosed herein were achieved in order to solve the foregoing problems in the related art, and herein is disclosed:

an imaging device capable of outputting an optical image of an object as an electric image signal, comprising:

a zoom lens system that forms an optical image of the object; and

an image sensor that converts the optical image formed by the zoom lens system into the electric image signal, wherein

the zoom lens system is a zoom lens system, in order from an object side to an image side, comprising:

a first lens unit having positive optical power;

a second lens unit having negative optical power;

a third lens unit having positive optical power;

a fourth lens unit having negative optical power; and

a fifth lens unit having positive optical power, wherein

the first lens unit is composed of three or more lens elements,

in zooming from a wide-angle limit to a telephoto limit at a time of image taking, at least the first lens unit, the second lens unit, and the third lens unit move with respect to an image surface,

a focusing lens unit, which moves with respect to the image surface in focusing from an infinity in-focus condition to a close-object in-focus condition, is provided,

the focusing lens unit is composed of one lens element, and

the following conditions (1) and (7) are satisfied:

3.2<L_{G3}/(f_{T}×tan(ω_{T})) (1)

0.3<f_{G1}/f_{T}<0.9 (7)

where

L_{G3} is an optical axial thickness of the third lens unit,

f_{T} is a focal length of the zoom lens system at the telephoto limit,

ω_{T} is a half view angle at the telephoto limit, and

f_{G1} is a focal length of the first lens unit.

The novel concepts disclosed herein were achieved in order to solve the foregoing problems in the related art, and herein is disclosed:

a camera for converting an optical image of an object into an electric image signal and then performing at least one of displaying and storing of the converted image signal, comprising:

an imaging device including a zoom lens system that forms an optical image of the object and an image sensor that converts the optical image formed by the zoom lens system into the electric image signal, wherein

the zoom lens system is a zoom lens system, in order from an object side to an image side, comprising:

a first lens unit having positive optical power;

a second lens unit having negative optical power;

a third lens unit having positive optical power;

a fourth lens unit having negative optical power; and

a fifth lens unit having positive optical power, wherein

the first lens unit is composed of three or more lens elements,

in zooming from a wide-angle limit to a telephoto limit at a time of image taking, at least the first lens unit, the second lens unit, and the third lens unit move with respect to an image surface,

a focusing lens unit, which moves with respect to the image surface in focusing from an infinity in-focus condition to a close-object in-focus condition, is provided,

the focusing lens unit is composed of one lens element, and

the following conditions (1) and (7) are satisfied:

3.2<L_{G3}/(f_{T}×tan(ω_{T})) (1)

0.3<f_{G1}/f_{T}<0.9 (7)

where

L_{G3} is an optical axial thickness of the third lens unit,

f_{T} is a focal length of the zoom lens system at the telephoto limit,

ω_{T} is a half view angle at the telephoto limit, and

f_{G1} is a focal length of the first lens unit.

The zoom lens system according to the present disclosure has, as well as a high resolution, a small size and a view angle of 80° or more at a wide-angle limit, which is satisfactorily adaptable for wide-angle image taking, and has a high zoom ratio of 24 or more, and further is a bright zoom lens system which has F-number of 2.8 or so from a wide-angle limit to a telephoto limit.

### BRIEF DESCRIPTION OF THE DRAWINGS

This and other objects and features of the present disclosure will become clear from the following description, taken in conjunction with the exemplary embodiments with reference to the accompanied drawings in which:

FIG. 1 is a lens arrangement diagram showing an infinity in-focus condition of a zoom lens system according to Embodiment 1 (Numerical Example 1);

FIG. 2 is a longitudinal aberration diagram of an infinity in-focus condition of the zoom lens system according to Numerical Example 1;

FIG. 3 is a lateral aberration diagram of the zoom lens system according to Numerical Example 1 at a telephoto limit in a basic state where image blur compensation is not performed and in an image blur compensation state;

FIG. 4 is a lens arrangement diagram showing an infinity in-focus condition of a zoom lens system according to Embodiment 2 (Numerical Example 2);

FIG. 5 is a longitudinal aberration diagram of an infinity in-focus condition of the zoom lens system according to Numerical Example 2;

FIG. 6 is a lateral aberration diagram of the zoom lens system according to Numerical Example 2 at a telephoto limit in a basic state where image blur compensation is not performed and in an image blur compensation state;

FIG. 7 is a lens arrangement diagram showing an infinity in-focus condition of a zoom lens system according to Embodiment 3 (Numerical Example 3);

FIG. 8 is a longitudinal aberration diagram of an infinity in-focus condition of the zoom lens system according to Numerical Example 3;

FIG. 9 is a lateral aberration diagram of the zoom lens system according to Numerical Example 3 at a telephoto limit in a basic state where image blur compensation is not performed and in an image blur compensation state;

FIG. 10 is a lens arrangement diagram showing an infinity in-focus condition of a zoom lens system according to Embodiment 4 (Numerical Example 4);

FIG. 11 is a longitudinal aberration diagram of an infinity in-focus condition of the zoom lens system according to Numerical Example 4;

FIG. 12 is a lateral aberration diagram of the zoom lens system according to Numerical Example 4 at a telephoto limit in a basic state where image blur compensation is not performed and in an image blur compensation state;

FIG. 13 is a lens arrangement diagram showing an infinity in-focus condition of a zoom lens system according to Embodiment 5 (Numerical Example 5);

FIG. 14 is a longitudinal aberration diagram of an infinity in-focus condition of the zoom lens system according to Numerical Example 5;

FIG. 15 is a lateral aberration diagram of the zoom lens system according to Numerical Example 5 at a telephoto limit in a basic state where image blur compensation is not performed and in an image blur compensation state;

FIG. 16 is a lens arrangement diagram showing an infinity in-focus condition of a zoom lens system according to Embodiment 6 (Numerical Example 6);

FIG. 17 is a longitudinal aberration diagram of an infinity in-focus condition of the zoom lens system according to Numerical Example 6;

FIG. 18 is a lateral aberration diagram of the zoom lens system according to Numerical Example 6 at a telephoto limit in a basic state where image blur compensation is not performed and in an image blur compensation state; and

FIG. 19 is a schematic construction diagram of a digital still camera according to Embodiment 7.

### DETAILED DESCRIPTION

Hereinafter, embodiments will be described with reference to the drawings as appropriate. However, descriptions more detailed than necessary may be omitted. For example, detailed description of already well known matters or description of substantially identical configurations may be omitted. This is intended to avoid redundancy in the description below, and to facilitate understanding of those skilled in the art.

It should be noted that the applicants provide the attached drawings and the following description so that those skilled in the art can fully understand this disclosure. Therefore, the drawings and description are not intended to limit the subject defined by the claims.

### Embodiments 1 to 6

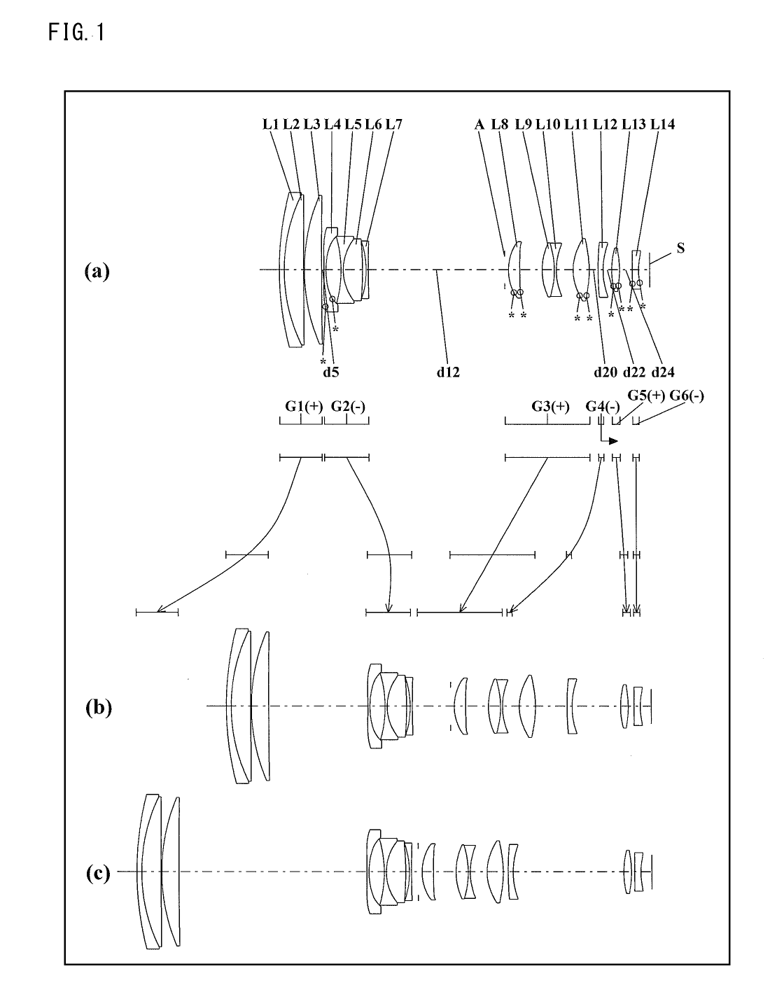

FIGS. 1, 4, 7, 10, 13, and 16 are lens arrangement diagrams of zoom lens systems according to Embodiments 1 to 6, respectively.

Each of FIGS. 1, 4, 7, 10, 13, and 16 shows a zoom lens system in an infinity in-focus condition. In each Fig., part (a) shows a lens configuration at a wide-angle limit (in the minimum focal length condition: focal length f_{W}), part (b) shows a lens configuration at a middle position (in an intermediate focal length condition: focal length f_{M}=\sqrt{(f_{W}*f_{T})}), and part (c) shows a lens configuration at a telephoto limit (in the maximum focal length condition: focal length f_{T}). Further, in each Fig., an arrow of straight or curved line provided between part (a) and part (b) indicates the movement of each lens unit from a wide-angle limit through a middle position to a telephoto limit. Moreover, in each Fig., an arrow imparted to a lens unit indicates focusing from an infinity in-focus condition to a close-object in-focus condition. That is, the arrow indicates the moving direction at the time of focusing from an infinity in-focus condition to a close-object in-focus condition.

In FIGS. 1, 4, 7, 10, 13, and 16, an asterisk “*” imparted to a particular surface indicates that the surface is aspheric. In each Fig., symbol (+) or (−) imparted to the symbol of each lens unit corresponds to the sign of the optical power of the lens unit. In each Fig., the straight line located on the most right-hand side indicates the position of the image surface S.

In FIGS. 1, 4, 7, 10, 13, and 16, an aperture diaphragm A is provided between the second lens unit G2 and the third lens unit G3.

### Embodiment 1

As shown in FIG. 1, the first lens unit G1, in order from the object side to the image side, comprises: a negative meniscus first lens element L1 with the convex surface facing the object side; a positive meniscus second lens element L2 with the convex surface facing the object side; and a positive meniscus third lens element L3 with the convex surface facing the object side. Among these, the first lens element L1 and the second lens element L2 are cemented with each other.

The second lens unit G2, in order from the object side to the image side, comprises: a bi-concave fourth lens element L4; a bi-concave fifth lens element L5; a bi-convex sixth lens element L6; and a bi-concave seventh lens element L7. Among these, the fifth lens element L5 and the sixth lens element L6 are cemented with each other. The fourth lens element L4 has two aspheric surfaces.

The third lens unit G3, in order from the object side to the image side, comprises: a positive meniscus eighth lens element L8 with the convex surface facing the object side; a bi-convex ninth lens element L9; a bi-concave tenth lens element L10; and a bi-convex eleventh lens element L11. Among these, the ninth lens element L9 and the tenth lens element L10 are cemented with each other. Each of the eighth lens element L8 and the eleventh lens element L11 has two aspheric surfaces.

The fourth lens unit G4 comprises solely a negative meniscus twelfth lens element L12 with the convex surface facing the object side.

The fifth lens unit G5 comprises solely a bi-convex thirteenth lens element L13. The thirteenth lens element L13 has two aspheric surfaces.

The sixth lens unit G6 comprises solely a negative meniscus fourteenth lens element L14 with the convex surface facing the object side. The fourteenth lens element L14 has two aspheric surfaces.

In zooming from a wide-angle limit to a telephoto limit at the time of image taking, the first lens unit G1 moves to the object side, the second lens unit G2 moves to the image side, the third lens unit G3 moves to the object side together with the aperture diaphragm A, the fourth lens unit G4 moves to the object side, the fifth lens unit G5 moves to the image side, and the sixth lens unit G6 does not move. That is, in zooming, the first lens unit G1, the second lens unit G2, the third lens unit G3, the fourth lens unit G4, and the fifth lens unit G5 individually move along the optical axis such that the interval between the first lens unit G1 and the second lens unit G2 increases, that the interval between the second lens unit G2 and the third lens unit G3 decreases, that the interval between the third lens unit G3 and the fourth lens unit G4 varies, that the interval between the fourth lens unit G4 and the fifth lens unit G5 increases, and that the interval between the fifth lens unit G5 and the sixth lens unit G6 decreases.

In focusing from an infinity in-focus condition to a close-object in-focus condition, the fourth lens unit G4 moves to the image side along the optical axis.

By moving the third lens unit G3, as an image blur compensating lens unit, in a direction perpendicular to the optical axis, image point movement caused by vibration of the entire system can be compensated. That is, image blur caused by hand blurring, vibration and the like can be compensated optically.

### Embodiment 2

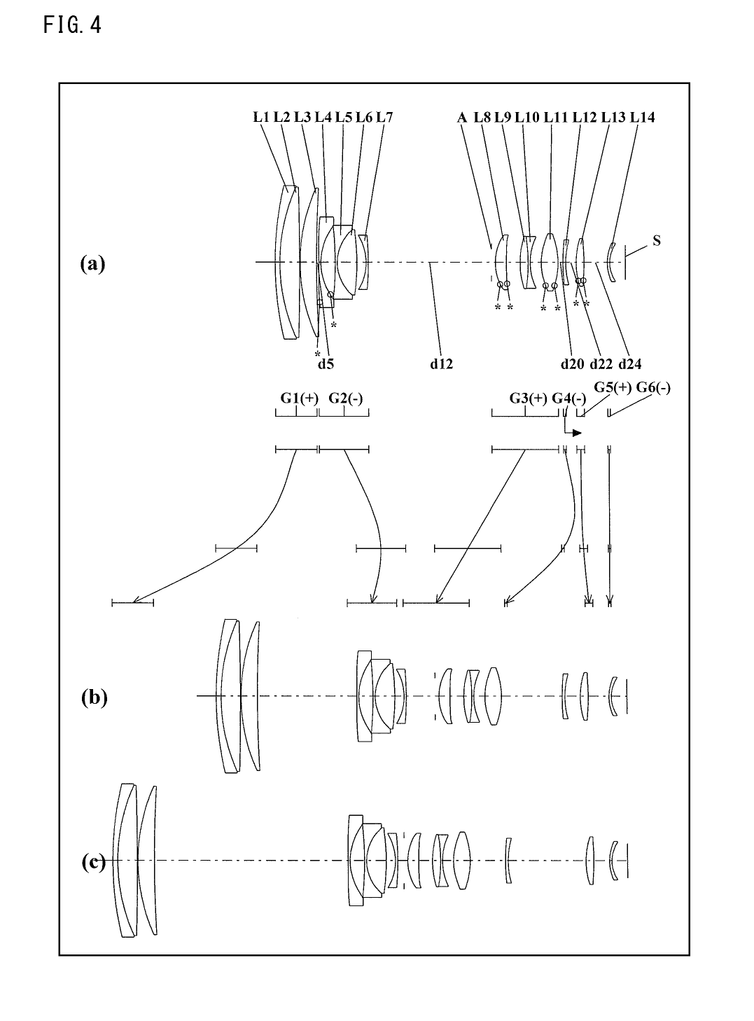

As shown in FIG. 4, the first lens unit G1, in order from the object side to the image side, comprises: a negative meniscus first lens element L1 with the convex surface facing the object side; a bi-convex second lens element L2; and a positive meniscus third lens element L3 with the convex surface facing the object side. Among these, the first lens element L1 and the second lens element L2 are cemented with each other.

The second lens unit G2, in order from the object side to the image side, comprises: a bi-concave fourth lens element L4; a bi-concave fifth lens element L5; a bi-convex sixth lens element L6; and a negative meniscus seventh lens element L7 with the convex surface facing the image side. Among these, the fifth lens element L5 and the sixth lens element L6 are cemented with each other. The fourth lens element L4 has two aspheric surfaces.

The third lens unit G3, in order from the object side to the image side, comprises: a positive meniscus eighth lens element L8 with the convex surface facing the object side; a bi-convex ninth lens element L9; a bi-concave tenth lens element L10; and a bi-convex eleventh lens element L11. Among these, the ninth lens element L9 and the tenth lens element L10 are cemented with each other. Each of the eighth lens element L8 and the eleventh lens element L11 has two aspheric surfaces.

The fourth lens unit G4 comprises solely a negative meniscus twelfth lens element L12 with the convex surface facing the object side.

The fifth lens unit G5 comprises solely a bi-convex thirteenth lens element L13. The thirteenth lens element L13 has two aspheric surfaces.

The sixth lens unit G6 comprises solely a negative meniscus fourteenth lens element L14 with the convex surface facing the object side.

In zooming from a wide-angle limit to a telephoto limit at the time of image taking, the first lens unit G1 moves to the object side, the second lens unit G2 moves to the image side, the third lens unit G3 moves to the object side together with the aperture diaphragm A, the fourth lens unit G4 moves to the object side, the fifth lens unit G5 moves to the image side, and the sixth lens unit G6 does not move. That is, in zooming, the first lens unit G1, the second lens unit G2, the third lens unit G3, the fourth lens unit G4, and the fifth lens unit G5 individually move along the optical axis such that the interval between the first lens unit G1 and the second lens unit G2 increases, that the interval between the second lens unit G2 and the third lens unit G3 decreases, that the interval between the third lens unit G3 and the fourth lens unit G4 varies, that the interval between the fourth lens unit G4 and the fifth lens unit G5 increases, and that the interval between the fifth lens unit G5 and the sixth lens unit G6 decreases.

In focusing from an infinity in-focus condition to a close-object in-focus condition, the fourth lens unit G4 moves to the image side along the optical axis.

By moving the eleventh lens element L11 which is a part of the third lens unit G3, as an image blur compensating lens unit, in a direction perpendicular to the optical axis, image point movement caused by vibration of the entire system can be compensated. That is, image blur caused by hand blurring, vibration and the like can be compensated optically.

### Embodiment 3

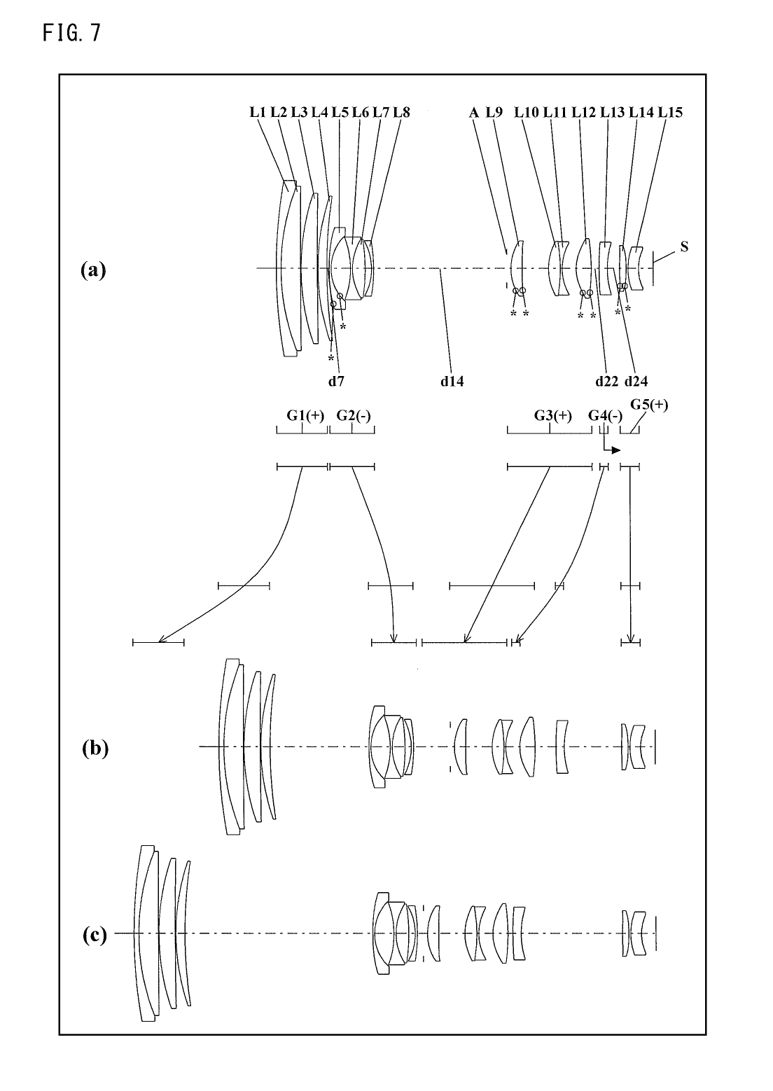

As shown in FIG. 7, the first lens unit G1, in order from the object side to the image side, comprises: a negative meniscus first lens element L1 with the convex surface facing the object side; a positive meniscus second lens element L2 with the convex surface facing the object side; a positive meniscus third lens element L3 with the convex surface facing the object side; and a positive meniscus fourth lens element L4 with the convex surface facing the object side. Among these, the first lens element L1 and the second lens element L2 are cemented with each other.

The second lens unit G2, in order from the object side to the image side, comprises: a negative meniscus fifth lens element L5 with the convex surface facing the object side; a bi-concave sixth lens element L6; a bi-convex seventh lens element L7; and a negative meniscus eighth lens element L8 with the convex surface facing the image side. Among these, the sixth lens element L6 and the seventh lens element L7 are cemented with each other. The fifth lens element L5 has two aspheric surfaces.

The third lens unit G3, in order from the object side to the image side, comprises: a positive meniscus ninth lens element L9 with the convex surface facing the object side; a bi-convex tenth lens element L10; a bi-concave eleventh lens element L11; and a bi-convex twelfth lens element L12. Among these, the tenth lens element L10 and the eleventh lens element L11 are cemented with each other. Each of the ninth lens element L9 and the twelfth lens element L12 has two aspheric surfaces.

The fourth lens unit G4 comprises solely a negative meniscus thirteenth lens element L13 with the convex surface facing the object side.

The fifth lens unit G5, in order from the object side to the image side, comprises: a bi-convex fourteenth lens element L14; and a negative meniscus fifteenth lens element L15 with the convex surface facing the object side. The fourteenth lens element L14 has two aspheric surfaces.

In zooming from a wide-angle limit to a telephoto limit at the time of image taking, the first lens unit G1 moves to the object side, the second lens unit G2 moves to the image side, the third lens unit G3 moves to the object side together with the aperture diaphragm A, the fourth lens unit G4 moves to the object side, and the fifth lens unit G5 does not move. That is, in zooming, the first lens unit G1, the second lens unit G2, the third lens unit G3, and the fourth lens unit G4 individually move along the optical axis such that the interval between the first lens unit G1 and the second lens unit G2 increases, that the interval between the second lens unit G2 and the third lens unit G3 decreases, that the interval between the third lens unit G3 and the fourth lens unit G4 varies, and that the interval between the fourth lens unit G4 and the fifth lens unit G5 increases.

In focusing from an infinity in-focus condition to a close-object in-focus condition, the fourth lens unit G4 moves to the image side along the optical axis.

By moving the third lens unit G3, as an image blur compensating lens unit, in a direction perpendicular to the optical axis, image point movement caused by vibration of the entire system can be compensated. That is, image blur caused by hand blurring, vibration and the like can be compensated optically.

### Embodiment 4

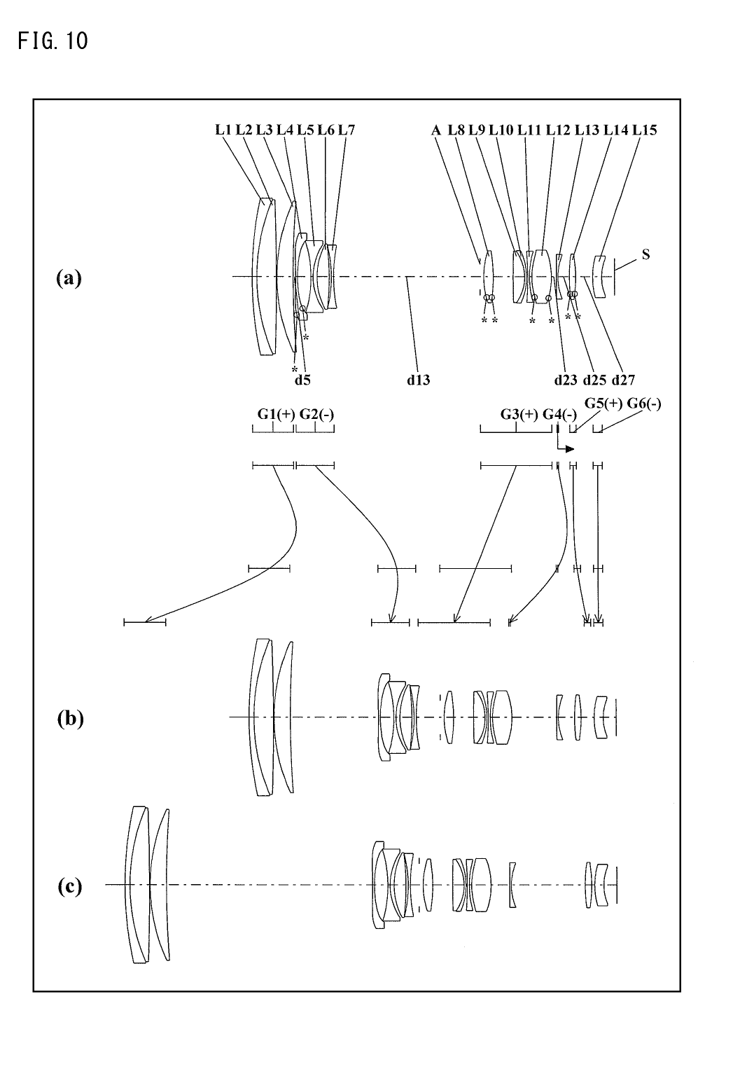

As shown in FIG. 10, the first lens unit G1, in order from the object side to the image side, comprises: a negative meniscus first lens element L1 with the convex surface facing the object side; a bi-convex second lens element L2; and a positive meniscus third lens element L3 with the convex surface facing the object side. Among these, the first lens element L1 and the second lens element L2 are cemented with each other.

The second lens unit G2, in order from the object side to the image side, comprises: a bi-concave fourth lens element L4; a bi-concave fifth lens element L5; a bi-convex sixth lens element L6; and a bi-concave seventh lens element L7. The fourth lens element L4 has two aspheric surfaces.

The third lens unit G3, in order from the object side to the image side, comprises: a bi-convex eighth lens element L8; a bi-convex ninth lens element L9; a negative meniscus tenth lens element L10 with the convex surface facing the image side; a bi-concave eleventh lens element L11; and a bi-convex twelfth lens element L12. Among these, the ninth lens element L9 and the tenth lens element L10 are cemented with each other. Each of the eighth lens element L8 and the twelfth lens element L12 has two aspheric surfaces.

The fourth lens unit G4 comprises solely a negative meniscus thirteenth lens element L13 with the convex surface facing the object side.

The fifth lens unit G5 comprises solely a bi-convex fourteenth lens element L14. The fourteenth lens element L14 has two aspheric surfaces.

The sixth lens unit G6 comprises solely a negative meniscus fifteenth lens element L15 with the convex surface facing the object side.

In zooming from a wide-angle limit to a telephoto limit at the time of image taking, the first lens unit G1 moves to the object side, the second lens unit G2 moves to the image side, the third lens unit G3 moves to the object side together with the aperture diaphragm A, the fourth lens unit G4 moves to the object side, the fifth lens unit G5 moves to the image side, and the sixth lens unit G6 does not move. That is, in zooming, the first lens unit G1, the second lens unit G2, the third lens unit G3, the fourth lens unit G4, and the fifth lens unit G5 individually move along the optical axis such that the interval between the first lens unit G1 and the second lens unit G2 increases, that the interval between the second lens unit G2 and the third lens unit G3 decreases, that the interval between the third lens unit G3 and the fourth lens unit G4 varies, that the interval between the fourth lens unit G4 and the fifth lens unit G5 increases, and that the interval between the fifth lens unit G5 and the sixth lens unit G6 decreases.

In focusing from an infinity in-focus condition to a close-object in-focus condition, the fourth lens unit G4 moves to the image side along the optical axis.

By moving three lens elements of the eighth lens element L8, the ninth lens element L9, and the tenth lens element L10, which are parts of the third lens unit G3, as an image blur compensating lens unit, in a direction perpendicular to the optical axis, image point movement caused by vibration of the entire system can be compensated. That is, image blur caused by hand blurring, vibration and the like can be compensated optically.

### Embodiment 5

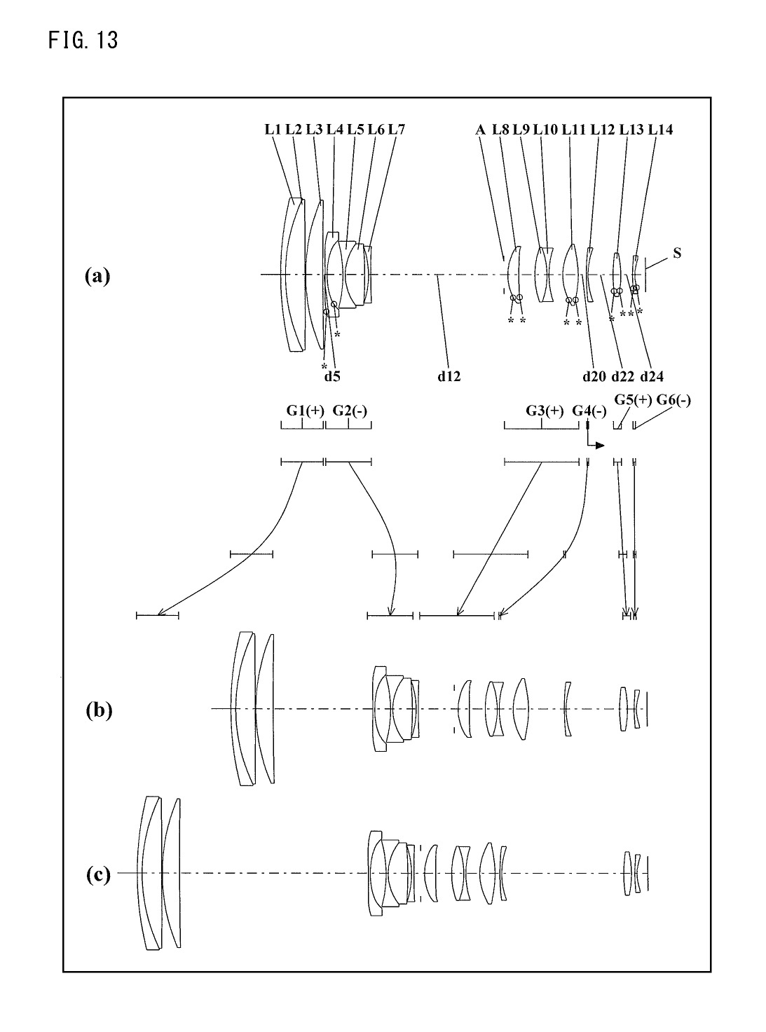

As shown in FIG. 13, the first lens unit G1, in order from the object side to the image side, comprises: a negative meniscus first lens element L1 with the convex surface facing the object side; a bi-convex second lens element L2; and a positive meniscus third lens element L3 with the convex surface facing the object side. Among these, the first lens element L1 and the second lens element L2 are cemented with each other.

The second lens unit G2, in order from the object side to the image side, comprises: a bi-concave fourth lens element L4; a bi-concave fifth lens element L5; a bi-convex sixth lens element L6; and a bi-concave seventh lens element L7. Among these, the fifth lens element L5 and the sixth lens element L6 are cemented with each other. The fourth lens element L4 has two aspheric surfaces.

The third lens unit G3, in order from the object side to the image side, comprises: a positive meniscus eighth lens element L8 with the convex surface facing the object side; a bi-convex ninth lens element L9; a bi-concave tenth lens element L10; and a bi-convex eleventh lens element L11. Among these, the ninth lens element L9 and the tenth lens element L10 are cemented with each other. Each of the eighth lens element L8 and the eleventh lens element L11 has two aspheric surfaces.

The fourth lens unit G4 comprises solely a negative meniscus twelfth lens element L12 with the convex surface facing the object side.

The fifth lens unit G5 comprises solely a bi-convex thirteenth lens element L13. The thirteenth lens element L13 has two aspheric surfaces.

The sixth lens unit G6 comprises solely a negative meniscus fourteenth lens element L14 with the convex surface facing the object side. The fourteenth lens element L14 has two aspheric surfaces.

In zooming from a wide-angle limit to a telephoto limit at the time of image taking, the first lens unit G1 moves to the object side, the second lens unit G2 moves to the image side, the third lens unit G3 moves to the object side together with the aperture diaphragm A, the fourth lens unit G4 moves to the object side, the fifth lens unit G5 moves to the image side, and the sixth lens unit G6 does not move. That is, in zooming, the first lens unit G1, the second lens unit G2, the third lens unit G3, the fourth lens unit G4, and the fifth lens unit G5 individually move along the optical axis such that the interval between the first lens unit G1 and the second lens unit G2 increases, that the interval between the second lens unit G2 and the third lens unit G3 decreases, that the interval between the third lens unit G3 and the fourth lens unit G4 varies, that the interval between the fourth lens unit G4 and the fifth lens unit G5 increases, and that the interval between the fifth lens unit G5 and the sixth lens unit G6 decreases.

In focusing from an infinity in-focus condition to a close-object in-focus condition, the fourth lens unit G4 moves to the image side along the optical axis.

By moving the third lens unit G3, as an image blur compensating lens unit, in a direction perpendicular to the optical axis, image point movement caused by vibration of the entire system can be compensated. That is, image blur caused by hand blurring, vibration and the like can be compensated optically.

### Embodiment 6

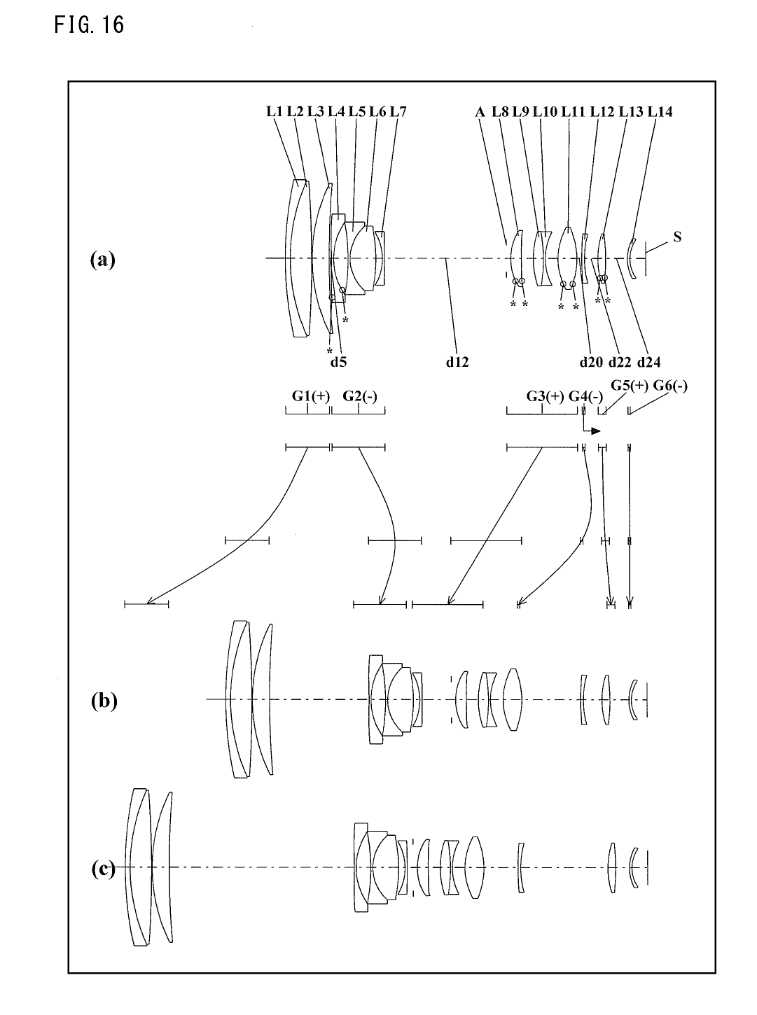

As shown in FIG. 16, the first lens unit G1, in order from the object side to the image side, comprises: a negative meniscus first lens element L1 with the convex surface facing the object side; a bi-convex second lens element L2; and a positive meniscus third lens element L3 with the convex surface facing the object side. Among these, the first lens element L1 and the second lens element L2 are cemented with each other.

The second lens unit G2, in order from the object side to the image side, comprises: a bi-concave fourth lens element L4; a bi-concave fifth lens element L5; a bi-convex sixth lens element L6; and a negative meniscus seventh lens element L7 with the convex surface facing the image side. Among these, the fifth lens element L5 and the sixth lens element L6 are cemented with each other. The fourth lens element L4 has two aspheric surfaces.

The third lens unit G3, in order from the object side to the image side, comprises: a positive meniscus eighth lens element L8 with the convex surface facing the object side; a bi-convex ninth lens element L9; a bi-concave tenth lens element L10; and a bi-convex eleventh lens element L11. Among these, the ninth lens element L9 and the tenth lens element L10 are cemented with each other. Each of the eighth lens element L8 and the eleventh lens element L11 has two aspheric surfaces.

The fourth lens unit G4 comprises solely a negative meniscus twelfth lens element L12 with the convex surface facing the object side.

The fifth lens unit G5 comprises solely a bi-convex thirteenth lens element L13. The thirteenth lens element L13 has two aspheric surfaces.

The sixth lens unit G6 comprises solely a negative meniscus fourteenth lens element L14 with the convex surface facing the object side.

In zooming from a wide-angle limit to a telephoto limit at the time of image taking, the first lens unit G1 moves to the object side, the second lens unit G2 moves to the image side, the third lens unit G3 moves to the object side together with the aperture diaphragm A, the fourth lens unit G4 moves to the object side, the fifth lens unit G5 moves to the image side, and the sixth lens unit G6 does not move. That is, in zooming, the first lens unit G1, the second lens unit G2, the third lens unit G3, the fourth lens unit G4, and the fifth lens unit G5 individually move along the optical axis such that the interval between the first lens unit G1 and the second lens unit G2 increases, that the interval between the second lens unit G2 and the third lens unit G3 decreases, that the interval between the third lens unit G3 and the fourth lens unit G4 varies, that the interval between the fourth lens unit G4 and the fifth lens unit G5 increases, and that the interval between the fifth lens unit G5 and the sixth lens unit G6 decreases.

In focusing from an infinity in-focus condition to a close-object in-focus condition, the fourth lens unit G4 moves to the image side along the optical axis.

By moving the eleventh lens element L11 which is a part of the third lens unit G3, as an image blur compensating lens unit, in a direction perpendicular to the optical axis, image point movement caused by vibration of the entire system can be compensated. That is, image blur caused by hand blurring, vibration and the like can be compensated optically.

In each of the zoom lens systems according to Embodiments 1 to 3, 5, and 6, the second lens unit G2 includes at least one cemented lens element. When the second lens unit G2 includes no cemented lens element, and a plurality of lens elements is closely positioned with each other, the degree of performance deterioration with respect to errors in air spaces is increased, which makes assembly of the optical system difficult.

In each of the zoom lens systems according to Embodiments 1 to 6, a focusing lens unit, i.e., the fourth lens unit G4, which moves with respect to the image surface in focusing from an infinity in-focus condition to a close-object in-focus condition, is provided, and the focusing lens unit is composed of one lens element. When the focusing lens unit is composed of a plurality of lens elements, an actuator for moving the focusing lens unit in the optical axial direction is increased in size, which makes it difficult to provide a compact lens barrel, imaging device, and camera.

In each of the zoom lens systems according to Embodiments 1 to 6, at least one lens unit is fixed with respect to the image surface in zooming from a wide-angle limit to a telephoto limit at the time of image taking. When all the lens units move with respect to the image surface in zooming, the configuration of a drive mechanism for the lens units is enlarged, which makes it difficult to provide a compact lens barrel, imaging device, and camera.

As described above, Embodiments 1 to 6 have been described as examples of art disclosed in the present application. However, the art in the present disclosure is not limited to these embodiments. It is understood that various modifications, replacements, additions, omissions, and the like have been performed in these embodiments to give optional embodiments, and the art in the present disclosure can be applied to the optional embodiments.

The following description is given for conditions that a zoom lens system like the zoom lens systems according to Embodiments 1 to 6 can satisfy. Here, a plurality of beneficial conditions is set forth for the zoom lens system according to each embodiment. A construction that satisfies all the plural conditions is most effective for the zoom lens system. However, when an individual condition is satisfied, a zoom lens system having the corresponding effect is obtained.

For example, in a zoom lens system like the zoom lens systems according to Embodiments 1 to 6, which comprises, in order from the object side to the image side, a first lens unit having positive optical power, a second lens unit having negative optical power, a third lens unit having positive optical power, a fourth lens unit having negative optical power, and a fifth lens unit having positive optical power, wherein the first lens unit is composed of three or more lens elements, in zooming from a wide-angle limit to a telephoto limit at the time of image taking, at least the first lens unit, the second lens unit, and the third lens unit move with respect to the image surface, a focusing lens unit, which moves with respect to the image surface in focusing from an infinity in-focus condition to a close-object in-focus condition, is provided, and the focusing lens unit is composed of one lens element (this lens configuration is referred to as a basic configuration of the embodiment, hereinafter), the following condition (1) is satisfied and it is beneficial that the condition (2) is satisfied.

3.2<L_{G3}/(f_{T}×tan(ω_{T})) (1)

2.0<|M_{G1}/(f_{T}×tan(ω_{T}))|<15.0 (2)

where

L_{G3} is an optical axial thickness of the third lens unit,

f_{T} is a focal length of the zoom lens system at the telephoto limit,

ω_{T} is a half view angle at the telephoto limit, and

M_{G1} is an amount of movement of the first lens unit in an optical axial direction in the zooming from the wide-angle limit to the telephoto limit at the time of image taking

M_{G1} is a value obtained by subtracting an optical axial distance between the image surface and a most object side surface of the first lens unit at the wide-angle limit, from an optical axial distance between the image surface and the most object side surface of the first lens unit at the telephoto limit.

The condition (1) sets forth the relationship between the optical axial thickness of the third lens unit, and the focal length of the zoom lens system and the half view angle at the telephoto limit. When the value goes below the lower limit of the condition (1), an interval of each lens element in the third lens unit becomes narrow, which makes it difficult to compensate curvature of field, in particular, at the telephoto limit. In addition, the degree of performance deterioration with respect to errors in the interval of each lens element is increased, which makes assembly of the optical system difficult.

The condition (2) sets forth the relationship between the amount of movement of the first lens unit in the optical axial direction in the zooming from the wide-angle limit to the telephoto limit at the time of image taking, and the focal length of the zoom lens system and the half view angle at the telephoto limit. When the value goes below the lower limit of the condition (2), a focal length of the first lens unit becomes short, and aberration fluctuation during magnification change increases, which makes it difficult to compensate various aberrations. As a result, it becomes difficult to realize a high zoom ratio. When the value exceeds the upper limit of the condition (2), the amount of movement of the first lens unit during magnification change increases, which makes it difficult to provide a compact lens barrel, imaging device, and camera.

When the following condition (1)′, and at least one of the following conditions (2)′-1 and (2)″ are satisfied, the above-mentioned effect is achieved more successfully.

3.6<L_{G3}/(f_{T}×tan(ω_{T})) (1)′

4.0<|M_{G1}/(f_{T}×tan(ω_{T}))| (2)′-1

|M_{G1}/(f_{T}×tan(ω_{T}))|<12.0 (2)″

When the following condition (1)″, and at least one of the following conditions (2)′-2 and (2)″ are satisfied, the above-mentioned effect is achieved more beneficially and successfully.

4.0<L_{G3}/(f_{T}×tan(ω_{T})) (1)″

6.0<|M_{G1}/(f_{T}×tan(ω_{T}))| (2)′-2

|M_{G1}/(f_{T}×tan(ω_{T}))|<12.0 (2)″

In a zoom lens system having the basic configuration, in which the second lens unit, in order from the object side to the image side, comprises a first lens element having negative optical power and a second lens element having negative optical power, like the zoom lens systems according to Embodiments 1 to 6, it is beneficial that the first lens element and the second lens element satisfy the following conditions (3) and (4).

4.1<|R₂ₐ/R_{2b}| (3)

−0.1<(R_{2b}−R_{2c})/(R_{2b}+R_{2c}) (4)

where

R₂ₐ is a radius of curvature of an object side surface of the first lens element,

R_{2b} is a radius of curvature of an image side surface of the first lens element, and

R_{2c} is a radius of curvature of an image side surface of the second lens element.

The condition (3) sets forth the relationship between the radius of curvature of the object side surface of a first negative lens element in the second lens unit, and the radius of curvature of the image side surface of the first negative lens element. When the value goes below the lower limit of the condition (3), the radius of curvature of the image side surface of the first negative lens element is long, and a curvature of the image side surface of the first negative lens element becomes weak, which makes it difficult to compensate spherical aberration, in particular, at the telephoto limit.

The condition (4) sets forth the relationship between the radius of curvature of the image side surface of the first negative lens element in the second lens unit, and the radius of curvature of the image side surface of a second negative lens element in the second lens unit. When the value goes below the lower limit of the condition (4), the radius of curvature of the image side surface of the first negative lens element is shorter than the radius of curvature of the image side surface of the second negative lens element, and the curvature of the image side surface of the first negative lens element becomes stronger than a curvature of the image side surface of the second negative lens element, which makes it difficult to compensate coma aberration, in particular, at the telephoto limit.

When the following conditions (3)′ and (4)′ are satisfied, the above-mentioned effect is achieved more successfully.

5.0<|R₂ₐ/R_{2b}| (3)′

0<(R_{2b}−R_{2c})/(R_{2b}+R_{2c}) (4)′

When the following conditions (3)″ and (4)″ are satisfied, the above-mentioned effect is achieved more beneficially and successfully.

6.0<|R₂ₐ/R_{2b}| (3)″

0.1<(R_{2b}−R_{2c})/(R_{2b}+R_{2c}) (4)″

In a zoom lens system having the basic configuration like the zoom lens systems according to Embodiments 1 to 6, it is beneficial that the third lens unit includes at least one lens element having positive optical power, and the following condition (5) is satisfied.

N₃ₚ<1.64 (5)

where

N₃ₚ is an average of refractive indices to the d-line of the at least one lens element having positive optical power, which constitutes the third lens unit.

The condition (5) sets forth the average of the refractive indices to the d-line of the at least one lens element having positive optical power, which constitutes the third lens unit. When the value exceeds the upper limit of the condition (5), optical power of the third lens unit becomes strong, which makes it difficult to compensate spherical aberration, in particular, at the telephoto limit. In addition, because a glass material having a high refractive index tends to have a high specific gravity, the weight of at least one lens element constituting the third lens unit is large. As a result, in case that the third lens unit is used as a lens unit for optically compensating image blur, the configuration of a drive mechanism for the lens unit is enlarged, which makes it difficult to provide a compact lens barrel, imaging device, and camera.

When the following condition (5)′ is satisfied, the above-mentioned effect is achieved more successfully.

N₃ₚ<1.59 (5)′

When the following condition (5)″ is satisfied, the above-mentioned effect is achieved more beneficially and successfully.

N₃ₚ<1.54 (5)″

In a zoom lens system having the basic configuration like the zoom lens systems according to Embodiments 1 to 6, it is beneficial to satisfy the following condition (6).

0.6<|M_{G4}/M_{G2}|<8.0 (6)

where

M_{G2} is an amount of movement of the second lens unit in an optical axial direction in the zooming from the wide-angle limit to the telephoto limit at the time of image taking, and

M_{G4} is an amount of movement of the fourth lens unit in an optical axial direction in the zooming from the wide-angle limit to the telephoto limit at the time of image taking

M_{G2} is a value obtained by subtracting an optical axial distance between the image surface and a most object side surface of the second lens unit at the wide-angle limit, from an optical axial distance between the image surface and the most object side surface of the second lens unit at the telephoto limit. M_{G4} is a value obtained by subtracting an optical axial distance between the image surface and a most object side surface of the fourth lens unit at the wide-angle limit, from an optical axial distance between the image surface and the most object side surface of the fourth lens unit at the telephoto limit.

The condition (6) sets forth the ratio of the amount of movement of the second lens unit in the optical axial direction to the amount of movement of the fourth lens unit in the optical axial direction, in the zooming from the wide-angle limit to the telephoto limit at the time of image taking. When the value goes below the lower limit of the condition (6), the amount of movement of the second lens unit becomes larger than the amount of movement of the fourth lens unit in the zooming, which makes it difficult to compensate astigmatism, in particular, at the telephoto limit. When the value exceeds the upper limit of the condition (6), the amount of movement of the fourth lens unit becomes larger than the amount of movement of the second lens unit in the zooming, which makes it difficult to compensate curvature of field, in particular, at the telephoto limit.

When at least one of the following conditions (6)′-1 and (6)″ is satisfied, the above-mentioned effect is achieved more successfully.

1.0<|M_{G4}/M_{G2}| (6)′-1

|M_{G4}/M_{G2}|<6.0 (6)″

When at least one of the following conditions (6)′-2 and (6)″ is satisfied, the above-mentioned effect is achieved more beneficially and successfully.

1.4<|M_{G4}/M_{G2}| (6)′-2

|M_{G4}/M_{G2}|<6.0 (6)″

In a zoom lens system having the basic configuration like the zoom lens systems according to Embodiments 1 to 6, the following condition (7) is satisfied.

0.3<f_{G1}/f_{T}<0.9 (7)

where

f_{G1} is a focal length of the first lens unit, and

f_{T} is the focal length of the zoom lens system at the telephoto limit.

The condition (7) sets forth the relationship between the focal length of the first lens unit and the focal length of the zoom lens system at the telephoto limit. When the value goes below the lower limit of the condition (7), the focal length of the first lens unit becomes short, and aberration fluctuation during magnification change increases, which makes it difficult to compensate various aberrations. As a result, it becomes difficult to realize a high zoom ratio. When the value exceeds the upper limit of the condition (7), the focal length of the first lens unit becomes long, and the amount of movement of the first lens unit during magnification change increases. As a result, it becomes difficult to provide a compact lens barrel, imaging device, and camera.

When at least one of the following conditions (7)′-1 and (7)″ is satisfied, the above-mentioned effect is achieved more successfully.

0.4<f_{G1}/f_{T} (7)′-1

f_{G1}/f_{T}<0.8 (7)″

When at least one of the following conditions (7)′-2 and (7)″ is satisfied, the above-mentioned effect is achieved more beneficially and successfully.

0.5<f_{g1}/f_{T} (7)′-2

f_{G1}/f_{T}<0.8 (7)″

In a zoom lens system having the basic configuration like the zoom lens systems according to Embodiments 1 to 6, it is beneficial to satisfy the following condition (8).

10<|(G_{4T}−G_{4M})/(G_{4M}−G_{4W})| (8)

where

G_{4w} is a distance from an object side inter-apex of the fourth lens unit to the image surface at the wide-angle limit,

G_{4T} is a distance from the object side inter-apex of the fourth lens unit to the image surface at the telephoto limit,

G_{4M} is a distance from the object side inter-apex of the fourth lens unit to the image surface at a middle position,

the middle position is a position at which a focal length f_{M} of the zoom lens system is represented by the following expression:

f_{M}=\sqrt{(f_{W}*f_{T})},

f_{W} is a focal length of the zoom lens system at the wide-angle limit, and

f_{T} is the focal length of the zoom lens system at the telephoto limit.

The condition (8) sets forth the distances from the object side inter-apex of the fourth lens unit to the image surface at the wide-angle limit, the telephoto limit, and the middle position, respectively. When the value goes below the lower limit of the condition (8), an interval between the fourth lens unit and the fifth lens unit at the telephoto limit becomes narrow. As a result, it becomes difficult to ensure a space for focusing in case that, for instance, the fourth lens unit is moved during focusing.

When the following condition (8)′ is satisfied, the above-mentioned effect is achieved more successfully.

15<|(G_{4T}−G_{4M})/(G_{4M}−G_{4W})| (8)′

When the following condition (8)″ is satisfied, the above-mentioned effect is achieved more beneficially and successfully.

20<|(G_{4T}−G_{4M})/(G_{4M}−G_{4W})| (8)″

In a zoom lens system having the basic configuration like the zoom lens systems according to Embodiments 1 to 6, it is beneficial to satisfy the following condition (9).

|M_{G5}/(f_{T}×tan(ω_{T}))|<1.5 (9)

where

M_{G5} is an amount of movement of the fifth lens unit in an optical axial direction in the zooming from the wide-angle limit to the telephoto limit at the time of image taking,

f_{T} is the focal length of the zoom lens system at the telephoto limit, and

ω_{T} is the half view angle at the telephoto limit.

M_{G5} is a value obtained by subtracting an optical axial distance between the image surface and a most object side surface of the fifth lens unit at the wide-angle limit, from an optical axial distance between the image surface and the most object side surface of the fifth lens unit at the telephoto limit.

The condition (9) sets forth the relationship between the amount of movement of the fifth lens unit in the optical axial direction in the zooming from the wide-angle limit to the telephoto limit at the time of image taking, and the focal length of the zoom lens system and the half view angle at the telephoto limit. When the value exceeds the upper limit of the condition (9), the amount of movement of the fifth lens unit assuming a role in compensation of the image surface increases, which makes it difficult to uniformly compensate the image surface at zooming position from the wide-angle limit to the telephoto limit.

When at least one of the following conditions (9)′-1 and (9)″-1 is satisfied, the above-mentioned effect is achieved more successfully.

0.2<|M_{G5}/(f_{T}×tan(ω_{T}))| (9)′-1

|M_{G5}/(f_{T}×tan(ω_{T}))|<1.4 (9)″-1

When at least one of the following conditions (9)′-2 and (9)″-2 is satisfied, the above-mentioned effect is achieved more beneficially and successfully.

0.4<|M_{G5}/(f_{T}×tan(ω_{T}))| (9)′-2

|M_{G5}/(f_{T}×tan(ω_{T}))|<1.3 (9)″-2

The individual lens units constituting the zoom lens systems according to Embodiments 1 to 6 are each composed exclusively of refractive type lens elements that deflect incident light by refraction (that is, lens elements of a type in which deflection is achieved at the interface between media having different refractive indices). However, the present disclosure is not limited to this construction. For example, the lens units may employ diffractive type lens elements that deflect incident light by diffraction; refractive-diffractive hybrid type lens elements that deflect incident light by a combination of diffraction and refraction; or gradient index type lens elements that deflect incident light by distribution of refractive index in the medium. In particular, in the refractive-diffractive hybrid type lens element, when a diffraction structure is formed in the interface between media having different refractive indices, wavelength dependence of the diffraction efficiency is improved. Thus, such a configuration is beneficial.

### Embodiment 7

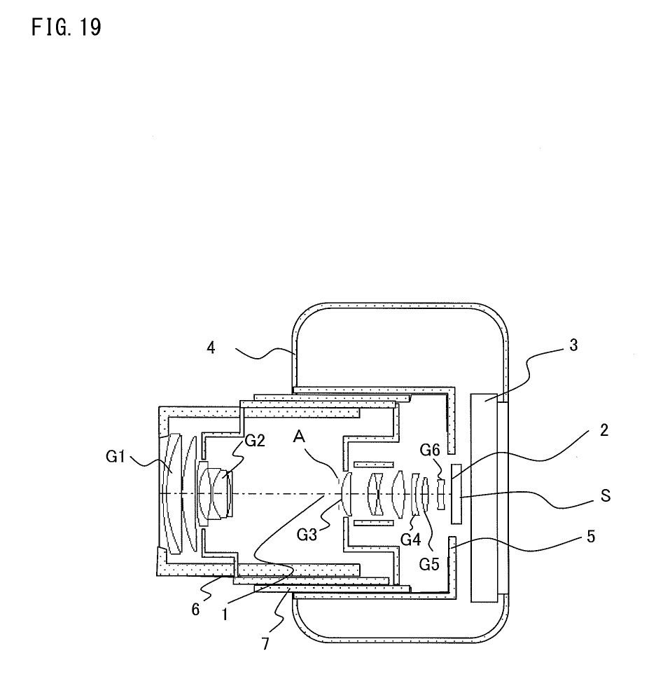

FIG. 19 is a schematic construction diagram of a digital still camera according to Embodiment 7. In FIG. 19, the digital still camera comprises: an imaging device having a zoom lens system 1 and an image sensor 2 composed of a CCD; a liquid crystal display monitor 3; and a body 4. The employed zoom lens system 1 is a zoom lens system according to Embodiment 1. In FIG. 19, the zoom lens system 1, in order from the object side to the image side, comprises a first lens unit G1, a second lens unit G2, an aperture diaphragm A, a third lens unit G3, a fourth lens unit G4, a fifth lens unit G5, and a sixth lens unit G6. In the body 4, the zoom lens system 1 is arranged on the front side, while the image sensor 2 is arranged on the rear side of the zoom lens system 1. On the rear side of the body 4, the liquid crystal display monitor 3 is arranged, while an optical image of a photographic object generated by the zoom lens system 1 is formed on an image surface S.

The lens barrel comprises a main barrel 5, a moving barrel 6 and a cylindrical cam 7. When the cylindrical cam 7 is rotated, the first lens unit G1, the second lens unit G2, the aperture diaphragm A and the third lens unit G3, the fourth lens unit G4, the fifth lens unit G5, and the sixth lens unit G6 move to predetermined positions relative to the image sensor 2, so that zooming from a wide-angle limit to a telephoto limit is achieved. The fourth lens unit G4 is movable in an optical axis direction by a motor for focus adjustment.

As such, when the zoom lens system according to Embodiment 1 is employed in a digital still camera, a small digital still camera is obtained that has a high resolution and high capability of compensating the curvature of field and that has a short overall length of lens system at the time of non-use. Here, in the digital still camera shown in FIG. 19, any one of the zoom lens systems according to Embodiments 2 to 6 may be employed in place of the zoom lens system according to Embodiment 1. Further, the optical system of the digital still camera shown in FIG. 19 is applicable also to a digital video camera for moving images. In this case, moving images with high resolution can be acquired in addition to still images.

Here, the digital still camera according to the present Embodiment 7 has been described for a case that the employed zoom lens system 1 is a zoom lens system according to Embodiments 1 to 6. However, in these zoom lens systems, the entire zooming range need not be used. That is, in accordance with a desired zooming range, a range where satisfactory optical performance is obtained may exclusively be used. Then, the zoom lens system may be used as one having a lower magnification than the zoom lens system described in Embodiments 1 to 6.

Further, Embodiment 7 has been described for a case that the zoom lens system is applied to a lens barrel of so-called barrel retraction construction. However, the present disclosure is not limited to this. For example, the zoom lens system may be applied to a lens barrel of so-called bending configuration where a prism having an internal reflective surface or a front surface reflective mirror is arranged at an arbitrary position within the first lens unit G1 or the like.

An imaging device comprising a zoom lens system according to Embodiments 1 to 6, and an image sensor such as a CCD or a CMOS may be applied to a camera for a mobile terminal device such as a smart-phone, a surveillance camera in a surveillance system, a Web camera, a vehicle-mounted camera or the like.

As described above, Embodiment 7 has been described as an example of art disclosed in the present application. However, the art in the present disclosure is not limited to this embodiment. It is understood that various modifications, replacements, additions, omissions, and the like have been performed in this embodiment to give optional embodiments, and the art in the present disclosure can be applied to the optional embodiments.

The following description is given for numerical examples in which the zoom lens system according to Embodiments 1 to 6 are implemented practically. In the numerical examples, the units of the length in the tables are all “mm”, while the units of the view angle are all “°”. Moreover, in the numerical examples, r is the radius of curvature, d is the axial distance, nd is the refractive index to the d-line, and vd is the Abbe number to the d-line. In the numerical examples, the surfaces marked with * are aspheric surfaces, and the aspheric surface configuration is defined by the following expression.

$$Z = \frac{{h}^{2} / r}{1 + \sqrt{1 - ( 1 + κ ) {( h / r )}^{2}}} + \sum {A}_{n} {h}^{n}$$

Here, the symbols in the formula indicate the following quantities.

Z is a distance from a point on an aspherical surface at a height h relative to the optical axis to a tangential plane at the vertex of the aspherical surface,

h is a height relative to the optical axis,

r is a radius of curvature at the top,

κ is a conic constant, and

Aₙ is an n-th order aspherical coefficient.

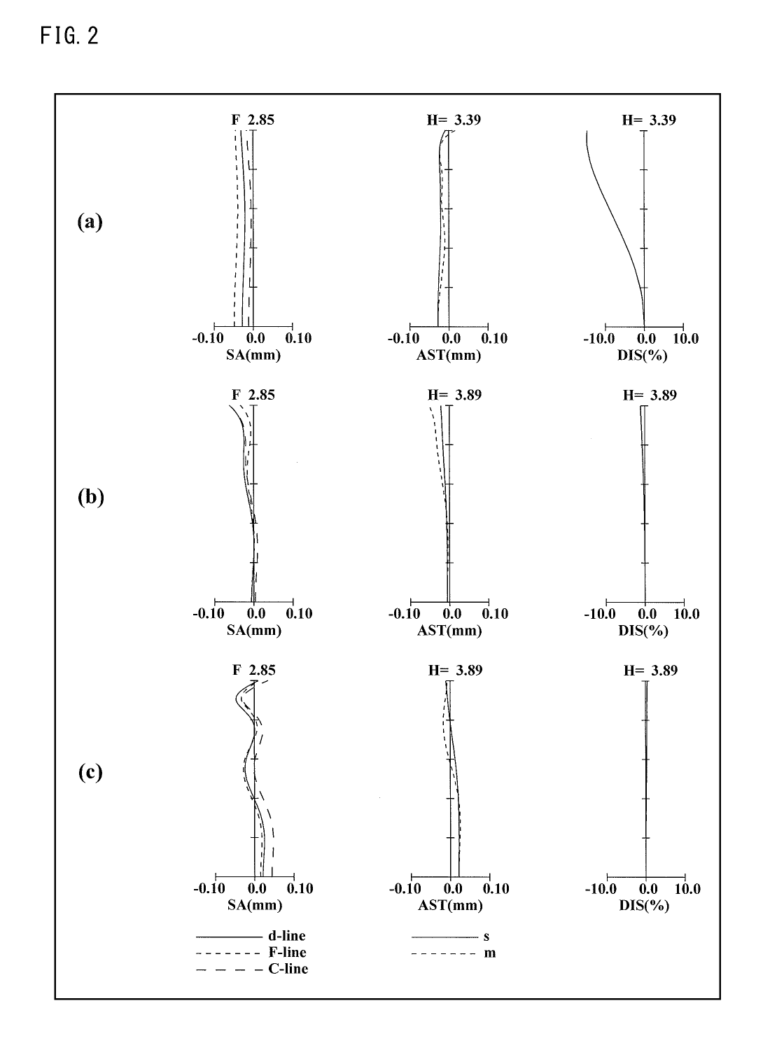

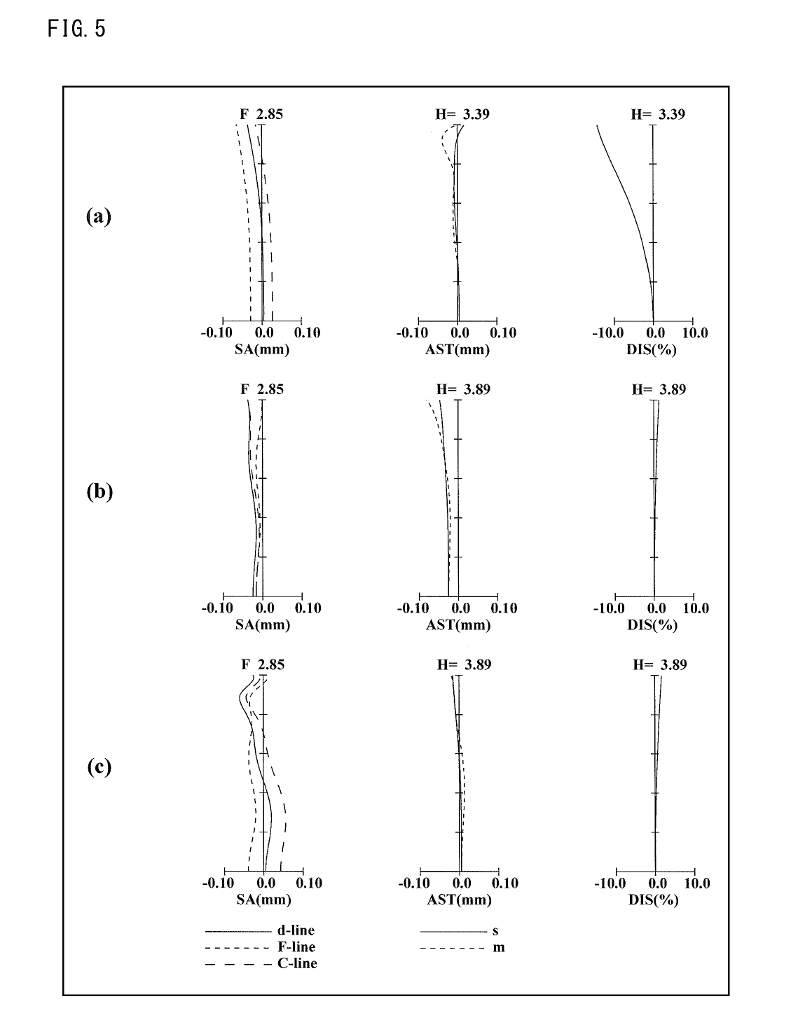

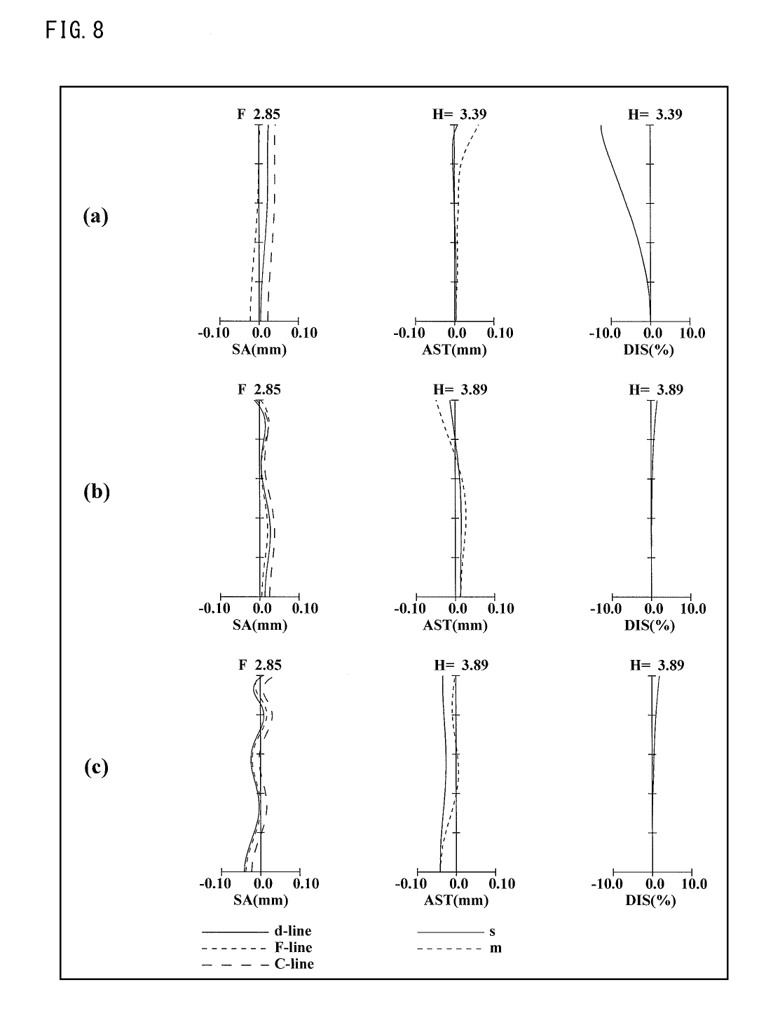

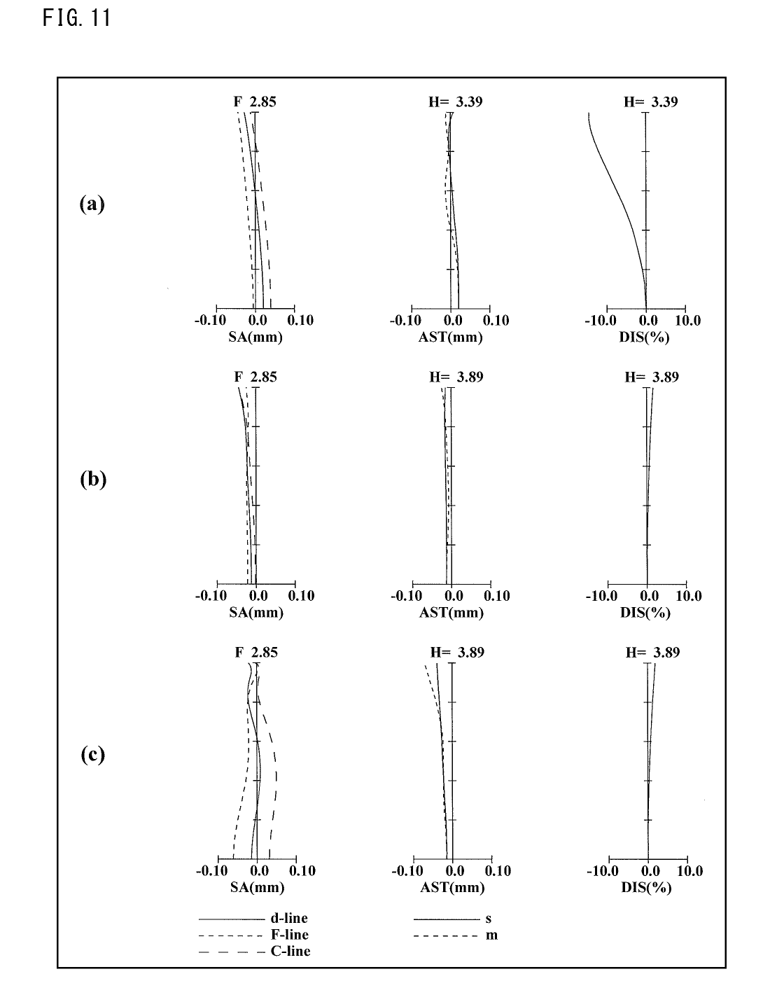

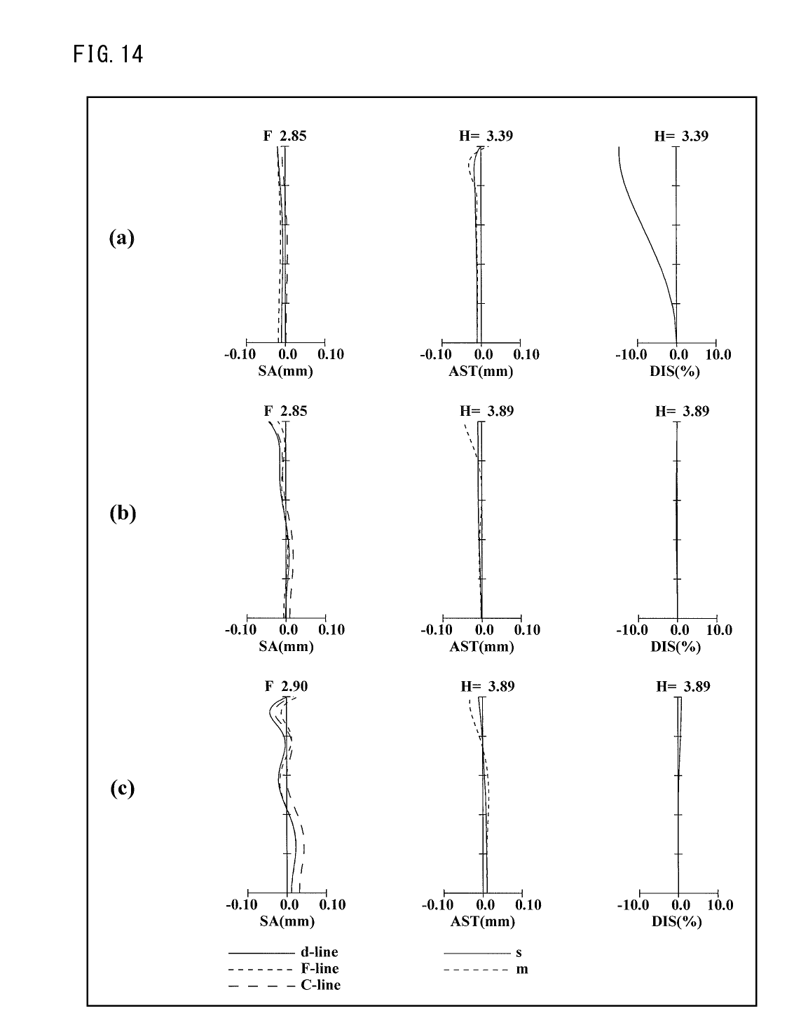

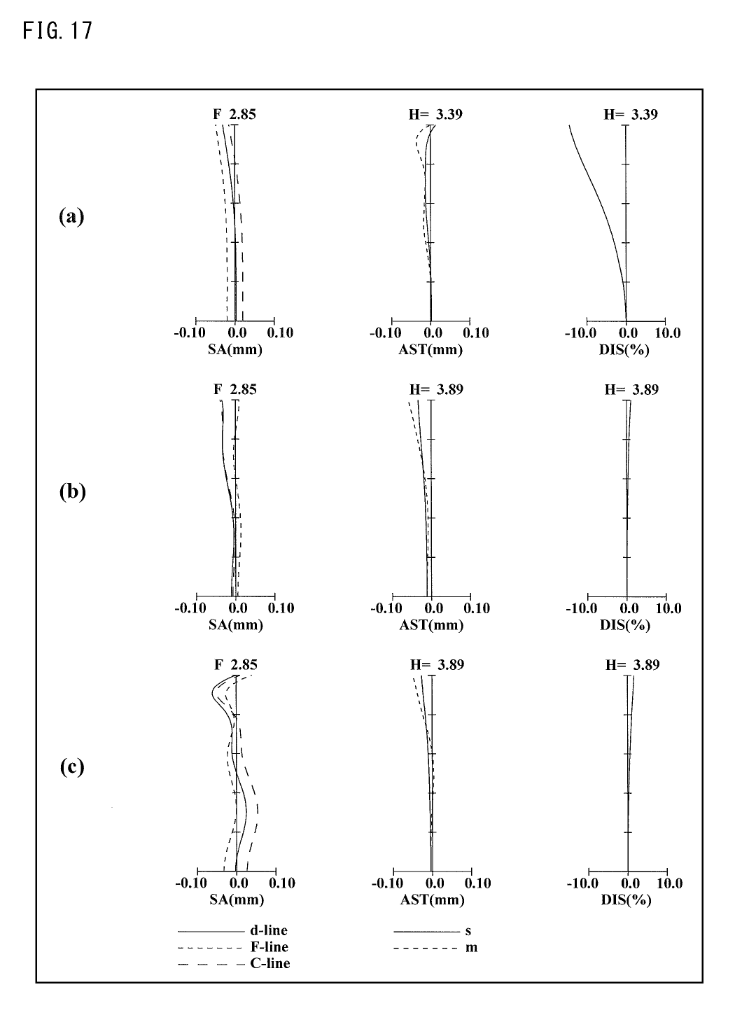

FIGS. 2, 5, 8, 11, 14, and 17 are longitudinal aberration diagrams of an infinity in-focus condition of the zoom lens systems according to Numerical Examples 1 to 6, respectively.

In each longitudinal aberration diagram, part (a) shows the aberration at a wide-angle limit, part (b) shows the aberration at a middle position, and part (c) shows the aberration at a telephoto limit. Each longitudinal aberration diagram, in order from the left-hand side, shows the spherical aberration (SA (mm)), the astigmatism (AST (mm)) and the distortion (DIS (%)). In each spherical aberration diagram, the vertical axis indicates the F-number (in each Fig., indicated as F), and the solid line, the short dash line and the long dash line indicate the characteristics to the d-line, the F-line and the C-line, respectively. In each astigmatism diagram, the vertical axis indicates the image height (in each Fig., indicated as H), and the solid line and the dash line indicate the characteristics to the sagittal plane (in each Fig., indicated as “s”) and the meridional plane (in each Fig., indicated as “m”), respectively. In each distortion diagram, the vertical axis indicates the image height (in each Fig., indicated as H).

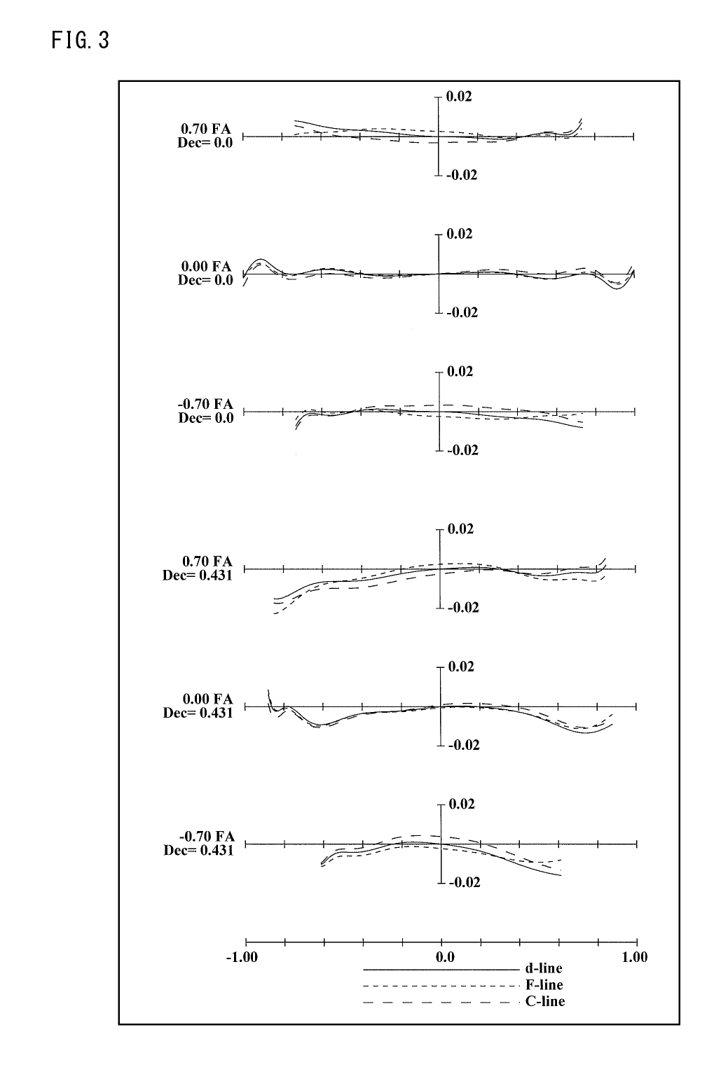

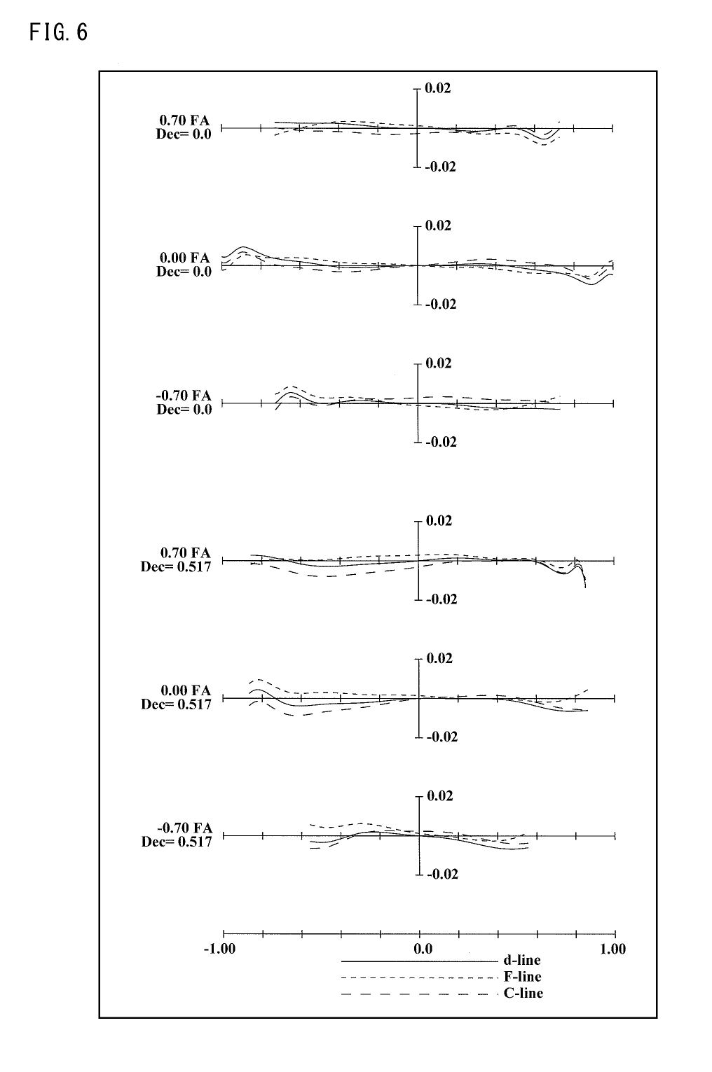

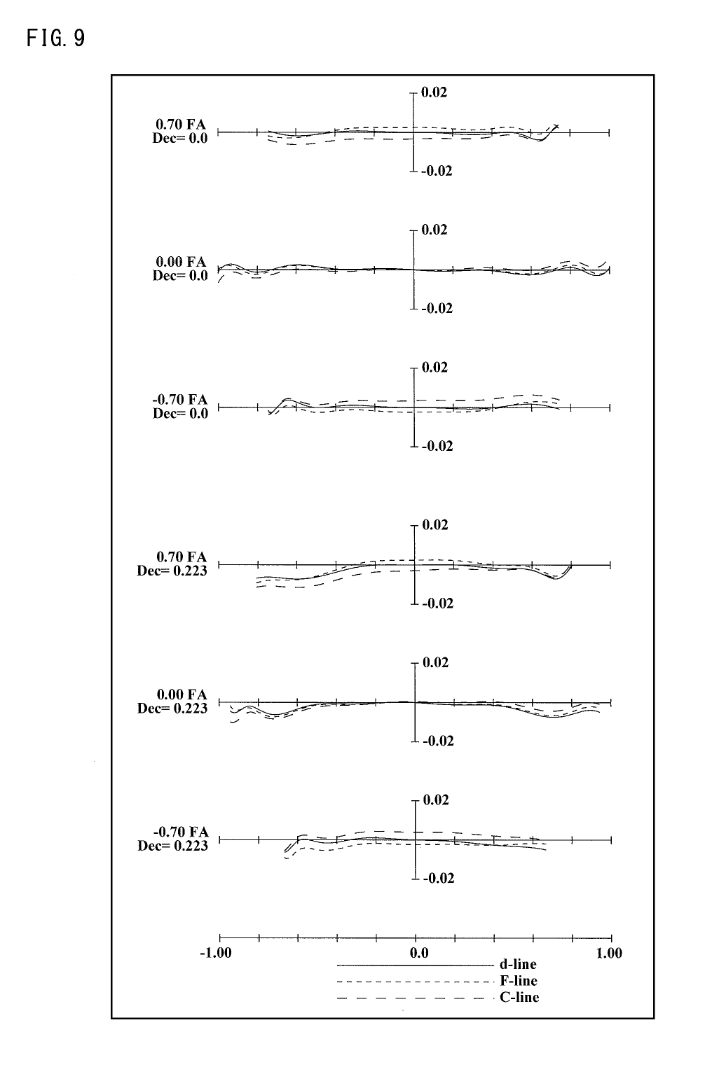

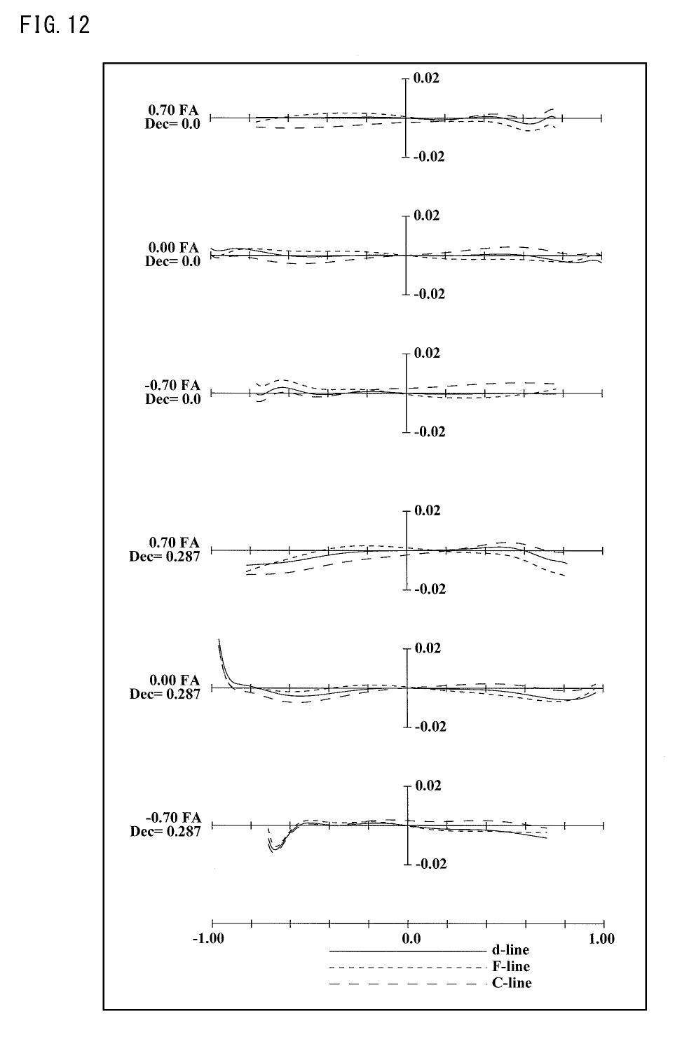

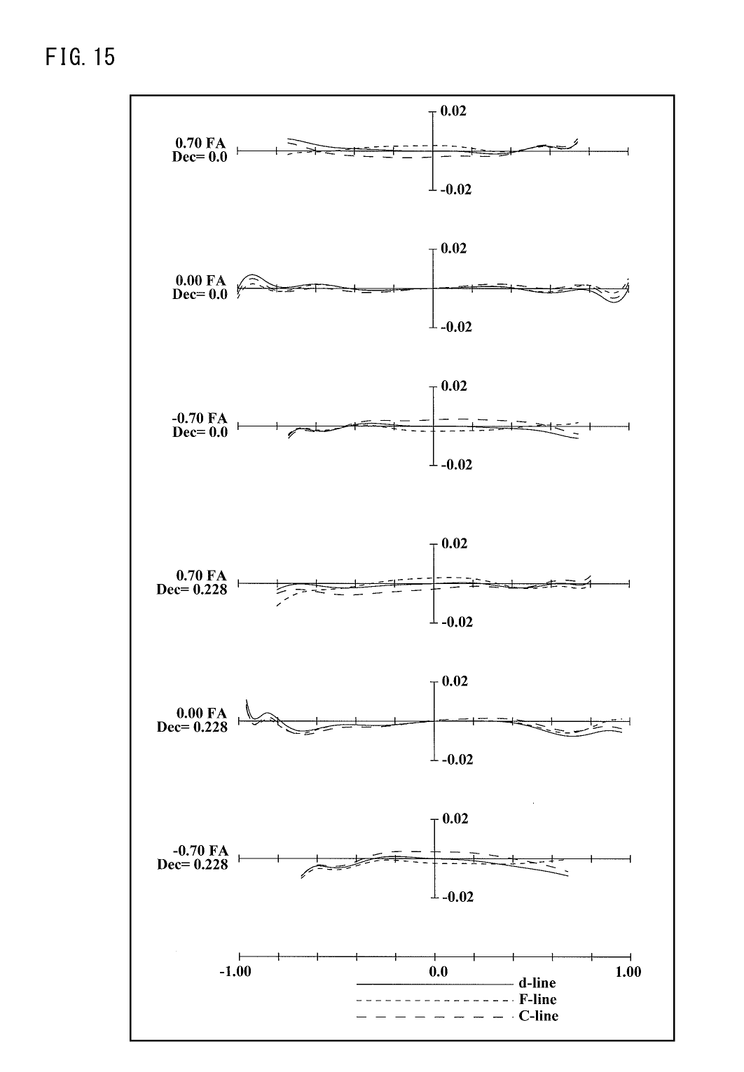

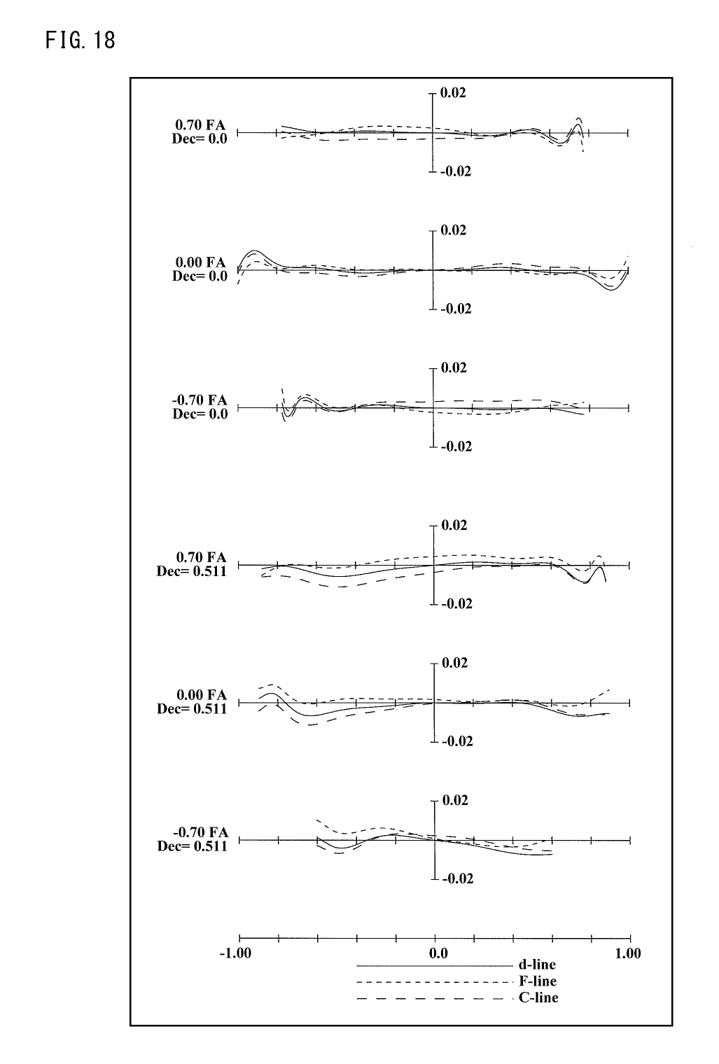

FIGS. 3, 6, 9, 12, 15, and 18 are lateral aberration diagrams of the zoom lens systems at a telephoto limit according to Numerical Examples 1 to 6, respectively.

In each lateral aberration diagram, the aberration diagrams in the upper three parts correspond to a basic state where image blur compensation is not performed at a telephoto limit, while the aberration diagrams in the lower three parts correspond to an image blur compensation state where the image blur compensating lens unit is moved by a predetermined amount in a direction perpendicular to the optical axis at a telephoto limit. Among the lateral aberration diagrams of a basic state, the upper part shows the lateral aberration at an image point of 70% of the maximum image height, the middle part shows the lateral aberration at the axial image point, and the lower part shows the lateral aberration at an image point of −70% of the maximum image height. Among the lateral aberration diagrams of an image blur compensation state, the upper part shows the lateral aberration at an image point of 70% of the maximum image height, the middle part shows the lateral aberration at the axial image point, and the lower part shows the lateral aberration at an image point of −70% of the maximum image height. In each lateral aberration diagram, the horizontal axis indicates the distance from the principal ray on the pupil surface, and the solid line, the short dash line and the long dash line indicate the characteristics to the d-line, the F-line and the C-line, respectively. In each lateral aberration diagram, the meridional plane is adopted as the plane containing the optical axis of the first lens unit G1 and the optical axis of the third lens unit G3.

Here, in the zoom lens system according to each example, the amount of movement of the image blur compensating lens unit in a direction perpendicular to the optical axis in an image blur compensation state at a telephoto limit is as follows.

| Numerical Example | Amount of movement (mm) |
|---|---|
| 1 | 0.431 |
| 2 | 0.517 |
| 3 | 0.223 |
| 4 | 0.287 |
| 5 | 0.228 |
| 6 | 0.511 |

In Numerical Examples 1, 2, and 6, when the shooting distance is infinity, at a telephoto limit, the amount of image decentering in a case that the zoom lens system inclines by 0.6° is equal to the amount of image decentering in a case that the image blur compensating lens unit displaces in parallel by each of the above-mentioned values in a direction perpendicular to the optical axis.

In Numerical Examples 3 to 5, when the shooting distance is infinity, at a telephoto limit, the amount of image decentering in a case that the zoom lens system inclines by 0.3° is equal to the amount of image decentering in a case that the image blur compensating lens unit displaces in parallel by each of the above-mentioned values in a direction perpendicular to the optical axis.

As seen from the lateral aberration diagrams, satisfactory symmetry is obtained in the lateral aberration at the axial image point. Further, when the lateral aberration at the +70% image point and the lateral aberration at the −70% image point are compared with each other in the basic state, all have a small degree of curvature and almost the same inclination in the aberration curve. Thus, decentering coma aberration and decentering astigmatism are small. This indicates that sufficient imaging performance is obtained even in the image blur compensation state. Further, when the image blur compensation angle of a zoom lens system is the same, the amount of parallel translation required for image blur compensation decreases with decreasing focal length of the entire zoom lens system. Thus, at arbitrary zoom positions, sufficient image blur compensation can be performed for image blur compensation angles up to 0.3° to 0.6° without degrading the imaging characteristics.

### Numerical Example 1

The zoom lens system of Numerical Example 1 corresponds to Embodiment 1 shown in FIG. 1. Table 1 shows the surface data of the zoom lens system of Numerical Example 1. Table 2 shows the aspherical data. Table 3 shows the various data.

TABLE 1
(Surface data)

| Surface number | r | d | nd | vd |
|---|---|---|---|---|
| Object surface | ∞ | | | |
| 1 | 77.26180 | 1.25000 | 1.90366 | 31.3 |
| 2 | 43.58840 | 4.99930 | 1.49700 | 81.6 |
| 3 | 3475.28240 | 0.15000 | | |
| 4 | 48.53490 | 4.40900 | 1.59282 | 68.6 |
| 5 | 1255.14270 | Variable | | |
| 6* | 173.72890 | 0.50000 | 1.88202 | 37.2 |
| 7* | 20.55860 | 3.88600 | | |
| 8 | −30.69750 | 0.55000 | 1.80420 | 46.5 |
| 9 | 12.74650 | 4.92640 | 1.92286 | 20.9 |
| 10 | −85.79200 | 0.95080 | | |
| 11 | −22.33630 | 0.55000 | 1.80420 | 46.5 |
| 12 | 221.20270 | Variable | | |
| 13 (Diaphragm) | ∞ | 1.00000 | | |
| 14* | 12.71340 | 2.88440 | 1.51760 | 63.5 |
| 15* | 176.37160 | 5.77000 | | |
| 16 | 16.59210 | 3.09530 | 1.43700 | 95.1 |
| 17 | −22.69720 | 0.50000 | 1.69895 | 30.0 |
| 18 | 16.81620 | 4.28870 | | |
| 19* | 12.47270 | 4.11140 | 1.52996 | 55.8 |
| 20* | −27.25680 | Variable | | |
| 21 | 76.43180 | 1.29130 | 1.43700 | 95.1 |
| 22 | 19.70840 | Variable | | |
| 23* | 18.51920 | 2.00000 | 1.52996 | 55.8 |
| 24* | −27.35030 | Variable | | |
| 25* | 93.41950 | 1.63940 | 1.88202 | 37.2 |
| 26* | 14.45290 | (BF) | | |
| Image surface | ∞ | | | |

TABLE 2
(Aspherical data)

Surface No. 6
K = 0.00000E+00, A4 = 7.03907E−06, A6 = 1.73538E−06,
A8 = −1.58316E−08
A10 = 6.92314E−11, A12 = −1.41360E−13, A14 = 0.00000E+00
Surface No. 7
K = 0.00000E+00, A4 = 9.20742E−06, A6 = 1.99757E−06,
A8 = −9.25527E−09
A10 = 1.55543E−10, A12 = −2.76001E−13, A14 = 0.00000E+00
Surface No. 14
K = 0.00000E+00, A4 = −2.21991E−05, A6 = −1.60020E−06,
A8 = 1.24976E−07
A10 = −3.39866E−09, A12 = 4.20857E−11, A14 = −1.53813E−16
Surface No. 15
K = 0.00000E+00, A4 = 3.22722E−05, A6 = −2.82561E−06,
A8 = 2.20595E−07
A10 = −6.12270E−09, A12 = 7.24126E−11, A14 = −5.87135E−16
Surface No. 19
K = 0.00000E+00, A4 = −8.89475E−05, A6 = −7.28424E−07,
A8 = 2.18418E−08
A10 = −2.17787E−10, A12 = 0.00000E+00, A14 = 0.00000E+00
Surface No. 20
K = 0.00000E+00, A4 = 6.08125E−05, A6 = −6.28035E−07,
A8 = 2.23874E−08
A10 = −2.14290E−10, A12 = 0.00000E+00, A14 = 0.00000E+00
Surface No. 23
K = 0.00000E+00, A4 = −2.52665E−04, A6 = 1.92989E−07,
A8 = 1.49693E−07
A10 = −4.63114E−11, A12 = 0.00000E+00, A14 = 0.00000E+00
Surface No. 24
K = 0.00000E+00, A4 = −1.64660E−04, A6 = 2.05481E−06,
A8 = 2.33718E−07
A10 = −2.08344E−09, A12 = 0.00000E+00, A14 = 0.00000E+00
Surface No. 25
K = 0.00000E+00, A4 = −8.10377E−05, A6 = −8.05120E−06,
A8 = −1.79624E−07
A10 = 9.89689E−09, A12 = 0.00000E+00, A14 = 0.00000E+00
Surface No. 26
K = 0.00000E+00, A4 = −1.47993E−04, A6 = −2.02818E−05,
A8 = −3.76149E−07
A10 = 2.19605E−08, A12 = 0.00000E+00, A14 = 0.00000E+00

TABLE 3
(Various data)

| Zooming ratio | 23.27974 | | |
|---|---|---|---|
| | Wide-angle | Middle | Telephoto |
| | limit | position | limit |
| Focal length | 4.6411 | 22.3922 | 108.0443 |
| F-number | 2.85063 | 2.85099 | 2.85105 |
| Half view angle | 41.2210 | 10.3348 | 2.0558 |
| Image height | 3.3930 | 3.8920 | 3.8920 |
| Overall length | 91.8431 | 105.7605 | 128.8431 |
| of lens system | | | |
| BF | 2.7714 | 2.7941 | 2.8211 |
| d5 | 0.6000 | 25.4000 | 48.1056 |
| d12 | 34.7765 | 9.7102 | 1.7014 |
| d20 | 2.2814 | 8.0955 | 1.2501 |
| d22 | 2.1794 | 12.3619 | 28.2340 |
| d24 | 3.2538 | 1.4409 | 0.8000 |

Zoom lens unit data

| Lens | Initial | Focal |
|---|---|---|
| unit | surface No. | length |
| 1 | 1 | 72.10667 |
| 2 | 6 | −9.08906 |
| 3 | 13 | 19.22679 |
| 4 | 21 | −61.19245 |
| 5 | 23 | 21.15566 |
| 6 | 25 | −19.57561 |

### Numerical Example 2

The zoom lens system of Numerical Example 2 corresponds to Embodiment 2 shown in FIG. 4. Table 4 shows the surface data of the zoom lens system of Numerical Example 2. Table 5 shows the aspherical data. Table 6 shows the various data.

TABLE 4
(Surface data)

| Surface number | r | d | nd | vd |
|---|---|---|---|---|
| Object surface | ∞ | | | |
| 1 | 83.96140 | 1.25000 | 1.90366 | 31.3 |
| 2 | 46.47590 | 4.99690 | 1.49700 | 81.6 |
| 3 | −709.80670 | 0.15000 | | |
| 4 | 46.04520 | 4.17910 | 1.59282 | 68.6 |
| 5 | 306.35190 | Variable | | |
| 6* | −263.78830 | 0.50000 | 1.88202 | 37.2 |
| 7* | 15.39430 | 3.66430 | | |
| 8 | −89.30300 | 0.55000 | 1.80420 | 46.5 |
| 9 | 11.00000 | 5.00000 | 1.92286 | 20.9 |
| 10 | −61.97480 | 2.38630 | | |
| 11 | −12.97010 | 0.55000 | 1.80420 | 46.5 |
| 12 | −84.04030 | Variable | | |
| 13(Diaphragm) | ∞ | 1.00000 | | |
| 14* | 13.16370 | 2.83280 | 1.61035 | 57.9 |
| 15* | 203.78650 | 3.48480 | | |
| 16 | 21.92920 | 2.08820 | 1.43700 | 95.1 |
| 17 | −40.98430 | 0.50000 | 1.75520 | 27.5 |
| 18 | 15.05090 | 2.80730 | | |
| 19* | 14.63730 | 4.28680 | 1.52500 | 70.3 |
| 20* | −18.33730 | Variable | | |
| 21 | 53.49830 | 0.70000 | 1.80000 | 29.8 |
| 22 | 20.74610 | Variable | | |
| 23* | 20.59310 | 2.00000 | 1.63550 | 23.9 |
| 24* | −48.84340 | Variable | | |
| 25 | 11.71490 | 0.60000 | 1.70154 | 41.1 |
| 26 | 8.39090 | (BF) | | |
| Image surface | ∞ | | | |

TABLE 5
(Aspherical data)

Surface No. 6
K = 0.00000E+00, A4 = 7.6359E−05, A6 = −8.20832E−07,
A8 = 7.29428E−09 A10 = −3.63091E−11, A12 = 7.05692E−14,
A14 = 0.00000E+00
Surface No. 7
K = 0.00000E+00, A4 = 5.04440E−05, A6 = −6.29251E−07,
A8 = 1.69006E−09 A10 = 7.65749E−11, A12 = −1.04523E−12,
A14 = 0.00000E+00
Surface No. 14
K = 0.00000E+00, A4 = 1.46776E−05, A6 = −1.58781E−06,
A8 = 1.32090E−07 A10 = −3.40616E−09, A12 = 4.17207E−11,
A14 = 4.05294E−17
Surface No. 15
K = 0.00000E+00, A4 = 8.53831E−05, A6 = −2.49793E−06,
A8 = 2.08242E−07 A10 = −5.68134E−09, A12 = 7.03937E−11,
A14 = −5.87133E−16
Surface No. 19
K = 0.00000E+00, A4 = −8.45850E−05, A6 = 7.53780E−08,
A8 = −4.09606E−09 A10 = 3.61828E−11, A12 = 0.00000E+00,
A14 = 0.00000E+00
Surface No. 20
K = 0.00000E+00, A4 = 3.89614E−05, A6 = 1.38892E−07,
A8 = −4.90556E−09 A10 = 4.79332E−11, A12 = 0.00000E+00,
A14 = 0.00000E+00
Surface No. 23
K = 0.00000E+00, A4 = 3.07337E−05, A6 = −3.04031E−06,
A8 = 1.30493E−07 A10 = −1.18745E−09, A12 = 0.00000E+00,
A14 = 0.00000E+00
Surface No. 24
K = 0.00000E+00, A4 = 9.23579E−05, A6 = −4.21265E−06,
A8 = 1.85834E−07 A10 = −1.99753E−09, A12 = 0.00000E+00,
A14 = 0.00000E+00

TABLE 6
(Various data)

| | |
|---|---|
| Zooming ratio | 23.27799 |

| | Wide-angle | Middle | Telephoto |
|---|---|---|---|
| | limit | position | limit |
| Focal length | 4.6406 | 22.3890 | 108.0242 |
| F-number | 2.85062 | 2.85017 | 2.85035 |
| Half view angle | 41.7241 | 10.8092 | 2.0067 |
| Image height | 3.3930 | 3.8917 | 3.8920 |
| Overall length | 85.5628 | 101.0141 | 127.5627 |
| of lens system | | | |
| BF | 4.0041 | 3.9749 | 4.0043 |
| d5 | 0.6000 | 25.4000 | 49.5829 |
| d12 | 31.5541 | 7.3942 | 1.6034 |
| d20 | 1.2500 | 15.4447 | 9.0177 |
| d22 | 2.6655 | 3.9412 | 19.8358 |
| d24 | 5.9667 | 5.3075 | 3.9964 |

Zoom lens unit data

| | Initial | |
|---|---|---|
| Lens unit | surface No. | Focal length |
| 1 | 1 | 73.39099 |
| 2 | 6 | −8.69400 |
| 3 | 13 | 17.82752 |
| 4 | 21 | −42.76525 |
| 5 | 23 | 23.05219 |
| 6 | 25 | −45.54273 |

### Numerical Example 3

The zoom lens system of Numerical Example 3 corresponds to Embodiment 3 shown in FIG. 7. Table 7 shows the surface data of the zoom lens system of Numerical Example 3. Table 8 shows the aspherical data. Table 9 shows the various data.

TABLE 7
(Surface data)

| Surface number | r | d | nd | vd |
|---|---|---|---|---|
| Object surface | ∞ | | | |
| 1 | 124.45980 | 1.25000 | 1.90366 | 31.3 |
| 2 | 57.01060 | 4.98570 | 1.49700 | 81.6 |
| 3 | 2762.40130 | 0.15000 | | |
| 4 | 59.57740 | 4.17970 | 1.59282 | 68.6 |
| 5 | 1143.79190 | 0.15000 | | |
| 6 | 56.24580 | 2.32830 | 1.49700 | 81.6 |
| 7 | 120.74790 | Variable | | |
| 8* | 51.26110 | 0.50000 | 1.88202 | 37.2 |
| 9* | 12.21230 | 4.92590 | | |
| 10 | −22.32630 | 0.55000 | 1.80420 | 46.5 |
| 11 | 14.25070 | 3.24550 | 1.92286 | 20.9 |
| 12 | −47.60180 | 1.61580 | | |
| 13 | −14.49640 | 0.55000 | 1.80420 | 46.5 |
| 14 | −40.59450 | Variable | | |
| 15(Diaphragm) | ∞ | 1.07740 | | |
| 16* | 12.85200 | 2.85900 | 1.51760 | 63.5 |
| 17* | 227.47230 | 6.73230 | | |
| 18 | 14.04740 | 3.00910 | 1.49700 | 81.6 |
| 19 | −40.95780 | 0.50000 | 1.69895 | 30.0 |
| 20 | 13.24750 | 3.59360 | | |
| 21* | 11.17310 | 3.86220 | 1.52996 | 55.8 |
| 22* | −44.69580 | Variable | | |
| 23 | 80.51560 | 2.13330 | 1.69384 | 53.1 |
| 24 | 22.35780 | Variable | | |
| 25* | 30.56000 | 1.66000 | 1.61035 | 57.9 |
| 26* | −60.47800 | 0.50100 | | |
| 27 | 15.90920 | 2.76060 | 1.80518 | 25.5 |
| 28 | 12.45570 | (BF) | | |
| Image surface | ∞ | | | |

TABLE 8
(Aspherical data)

Surface No. 8
K = 0.00000E+00, A4 = −2.15652E−05, A6 = 1.69349E−06,
A8 = −1.94115E−08 A10 = 8.49738E−11, A12 = −9.61072E−14,
A14 = 0.00000E+00
Surface No. 9
K = 0.00000E+00, A4 = −2.49121E−05, A6 = 1.27123E−06,
A8 = 1.41551E−08 A10 = −2.61562E−10, A12 = 4.44913E−13,
A14 = 0.00000E+00
Surface No. 16
K = 0.00000E+00, A4 = −3.04137E−05, A6 = −1.68911E−06,
A8 = 1.20172E−07 A10 = −3.34117E−09, A12 = 4.21124E−11,
A14 = 7.45635E−16
Surface No. 17
K = 0.00000E+00, A4 = 2.14583E−05, A6 = −3.08631E−06,
A8 = 2.21305E−07 A10 = −6.10459E−09, A12 = 7.23383E−11,
A14 = −7.26924E−15
Surface No. 21
K = 0.00000E+00, A4 = −1.02865E−04, A6 = −1.00237E−06,
A8 = 1.89860E−08 A10 = −2.96477E−10, A12 = 0.00000E+00,
A14 = 0.00000E+00
Surface No. 22
K = 0.00000E+00, A4 = 6.32235E−05, A6 = −6.67878E−07,
A8 = 1.56517E−08 A10 = 2.38086E−10, A12 = 0.00000E+00,
A14 = 0.00000E+00
Surface No. 25
K = 0.00000E+00, A4 = −5.30369E−04, A6 = 1.28246E−06,
A8 = −1.65118E−08 A10 = 1.25837E−09, A12 = 0.00000E+00,
A14 = 0.00000E+00
Surface No. 26
K = 0.00000E+00, A4 = −5.81172E−04, A6 = 3.79435E−06,
A8 = 1.50369E−08 A10 = 3.61571E−10, A12 = 0.00000E+00,
A14 = 0.00000E+00

TABLE 9
(Various data)

| Zooming ratio | 23.30577 | | |
|---|---|---|---|
| | Wide-angle | Middle | Telephoto |
| | limit | position | limit |
| Focal length | 4.5799 | 22.1224 | 106.7388 |
| F-number | 2.85077 | 2.85037 | 2.85014 |
| Half view angle | 40.6642 | 9.9776 | 1.9641 |
| Image height | 3.3930 | 3.8920 | 3.8920 |
| Overall length | 92.8788 | 107.9142 | 129.8019 |
| of lens system | | | |
| BF | 3.6236 | 3.6332 | 3.5781 |
| d7 | 0.6000 | 25.3493 | 48.0279 |
| d14 | 34.0543 | 9.4275 | 1.5344 |
| d22 | 1.9978 | 5.3632 | 1.2632 |
| d24 | 3.1073 | 14.6548 | 25.8570 |

Zoom lens unit data

| | Initial | |
|---|---|---|
| Lens unit | surface No. | Focal length |
| 1 | 1 | 71.12830 |
| 2 | 8 | −8.64638 |
| 3 | 15 | 18.40932 |
| 4 | 23 | −45.29138 |
| 5 | 25 | 41.49418 |

### Numerical Example 4

The zoom lens system of Numerical Example 4 corresponds to Embodiment 4 shown in FIG. 10. Table 10 shows the surface data of the zoom lens system of Numerical Example 4. Table 11 shows the aspherical data. Table 12 shows the various data.

TABLE 10
(Surface data)

| Surface number | r | d | nd | vd |
|---|---|---|---|---|
| Object surface | ∞ | | | |
| 1 | 92.75920 | 1.25000 | 1.90366 | 31.3 |
| 2 | 49.80050 | 5.00000 | 1.49700 | 81.6 |
| 3 | −562.50160 | 0.15000 | | |
| 4 | 45.96440 | 4.16140 | 1.59282 | 68.6 |
| 5 | 244.72290 | Variable | | |
| 6* | −200.89350 | 0.50000 | 1.84973 | 40.6 |
| 7* | 29.28690 | 3.44440 | | |
| 8 | −30.43030 | 0.55000 | 1.80420 | 46.5 |
| 9 | 14.83270 | 1.02260 | | |
| 10 | 17.72110 | 3.06220 | 2.00171 | 20.7 |
| 11 | −68.91810 | 0.56950 | | |
| 12 | −32.12080 | 0.55000 | 1.80420 | 46.5 |
| 13 | 39.88410 | Variable | | |
| 14(Diaphragm) | ∞ | 1.00000 | | |
| 15* | 19.84410 | 2.42830 | 1.52500 | 70.4 |
| 16* | −37.86360 | 5.09380 | | |
| 17 | 201.22880 | 2.95500 | 1.43700 | 95.1 |
| 18 | −11.24150 | 0.50000 | 1.80518 | 25.5 |
| 19 | −15.90840 | 0.30000 | | |
| 20 | −82.66520 | 0.50000 | 1.69320 | 33.7 |
| 21 | 23.32440 | 0.60000 | | |
| 22* | 17.37980 | 4.96580 | 1.52500 | 70.4 |
| 23* | −20.09370 | Variable | | |
| 24 | 1000.55010 | 0.40000 | 1.49700 | 81.6 |
| 25 | 14.57800 | Variable | | |
| 26* | 41.35120 | 1.65160 | 1.84973 | 40.6 |
| 27* | −28.97700 | Variable | | |
| 28 | 19.93230 | 2.29380 | 1.85135 | 40.1 |
| 29 | 12.19080 | (BF) | | |
| Image surface | ∞ | | | |

TABLE 11
(Aspherical data)

Surface No. 6
K = 0.00000E+00, A4 = −3.62599E−05, A6 = 2.13649E−06,
A8 = −2.07363E−08 A10 = 1.26497E−10, A12 = −2.93497E−13,
A14 = 0.00000E+00
Surface No. 7
K = 0.00000E+00, A4 = −5.97899E−05, A6 = 1.45668E−06,
A8 = 1.33947E−08 A10 = −3.72182E−10, A12 = 3.08502E−12,
A14 = 0.00000E+00
Surface No. 15
K = 0.00000E+00, A4 = −6.92258E−06, A6 = −3.69585E−06,
A8 = 1.97004E−07 A10 = −5.72682E−09, A12 = 6.87423E−11,
A14 = −3.22728E−16
Surface No. 16
K = 0.00000E+00, A4 = 5.40466E−05, A6 = −3.54952E−06,
A8 = 1.84169E−07 A10 = −5.46057E−09, A12 = 6.63289E−11,
A14 = −3.59594E−16
Surface No. 22
K = 0.00000E+00, A4 = −7.56769E−05, A6 = −8.10168E−07,
A8 = 4.88590E−09 A10 = −2.94581E−10, A12 = 0.00000E+00,
A14 = 0.00000E+00
Surface No. 23
K = 0.00000E+00, A4 = −1.39708E−05, A6 = −5.53748E−07,
A8 = −1.59134E−10 A10 = −2.03175E−10, A12 = 0.00000E+00,
A14 = 0.00000E+00
Surface No. 26
K = 0.00000E+00, A4 = 6.38132E−05, A6 = −9.97756E−06,
A8 = 3.83966E−07 A10 = −3.38587E−09, A12 = 0.00000E+00,
A14 = 0.00000E+00
Surface No. 27
K = 0.00000E+00, A4 = 1.50576E−04, A6 = −1.14359E−05,
A8 = 4.37691E−07 A10 = −4.02267E−09, A12 = 0.00000E+00,
A14 = 0.00000E+00

TABLE 12
(Various data)

| Zooming ratio | 23.21500 | | |
|---|---|---|---|
| | Wide-angle | Middle | Telephoto |
| | limit | position | limit |
| Focal length | 4.6406 | 22.3285 | 107.7322 |
| F-number | 2.85011 | 2.85047 | 2.85021 |
| Half view angle | 41.3503 | 11.6157 | 1.9900 |
| Image height | 3.3930 | 3.8920 | 3.8920 |
| Overall length | 89.4884 | 92.6047 | 122.3765 |
| of lens system | | | |
| BF | 3.3502 | 3.3171 | 3.3154 |
| d5 | 0.6000 | 22.5341 | 52.6386 |
| d13 | 37.4487 | 6.1094 | 2.2640 |
| d23 | 1.2651 | 13.4940 | 4.8143 |
| d25 | 2.9183 | 4.1526 | 18.9112 |
| d27 | 4.3079 | 3.3662 | 0.8000 |

Zoom lens unit data

| | Initial | |
|---|---|---|
| Lens unit | surface No. | Focal length |
| 1 | 1 | 77.24939 |
| 2 | 6 | −10.48009 |
| 3 | 14 | 16.79812 |
| 4 | 24 | −29.76985 |
| 5 | 26 | 20.26944 |
| 6 | 28 | −42.68462 |

### Numerical Example 5

The zoom lens system of Numerical Example 5 corresponds to Embodiment 5 shown in FIG. 13. Table 13 shows the surface data of the zoom lens system of Numerical Example 5. Table 14 shows the aspherical data. Table 15 shows the various data.

TABLE 13
(Surface data)

| Surface number | r | d | nd | vd |
|---|---|---|---|---|
| Object surface | ∞ | | | |
| 1 | 79.99790 | 1.25000 | 1.90366 | 31.3 |
| 2 | 44.45100 | 5.00000 | 1.49700 | 81.6 |
| 3 | −2961.73330 | 0.15000 | | |
| 4 | 48.37520 | 4.38830 | 1.59282 | 68.6 |
| 5 | 977.07150 | Variable | | |
| 6* | −142.90770 | 0.50000 | 1.88202 | 37.2 |
| 7* | 21.72240 | 4.03380 | | |
| 8 | −31.34780 | 0.55000 | 1.80420 | 46.5 |
| 9 | 12.65040 | 5.00000 | 1.92286 | 20.9 |
| 10 | −88.87860 | 0.96330 | | |
| 11 | −21.85110 | 0.55000 | 1.80420 | 46.5 |
| 12 | 164.29950 | Variable | | |
| 13(Diaphragm) | ∞ | 1.00000 | | |
| 14* | 13.05890 | 2.81550 | 1.51760 | 63.5 |
| 15* | 165.96890 | 4.10030 | | |
| 16 | 20.46970 | 3.10000 | 1.43700 | 95.1 |
| 17 | −19.38200 | 0.50000 | 1.69895 | 30.0 |
| 18 | 21.16650 | 3.54760 | | |
| 19* | 13.11100 | 3.93670 | 1.52996 | 55.8 |
| 20* | −24.15390 | Variable | | |
| 21 | 56.36440 | 0.44540 | 1.43700 | 95.1 |
| 22 | 19.05840 | Variable | | |
| 23* | 25.15790 | 2.00000 | 1.69384 | 53.1 |
| 24* | −29.61790 | Variable | | |
| 25* | 25.86320 | 0.60000 | 1.63550 | 23.9 |
| 26* | 9.34160 | (BF) | | |
| Image surface | ∞ | | | |

TABLE 14
(Aspherical data)

Surface No. 6
K = 0.00000E+00, A4 = 2.91294E−05, A6 = 1.35644E−06,
A8 = −1.27422E−08 A10 = 5.43760E−11, A12 = −1.09375E−13,
A14 = 0.00000E+00
Surface No. 7
K = 0.00000E+00, A4 = 3.07597E−05, A6 = 1.54032E−06,
A8 = −3.12503E−09 A10 = 8.97954E−11, A12 = −2.50830E−13,
A14 = 0.00000E+00
Surface No. 14
K = 0.00000E+00, A4 = 3.60684E−06, A6 = −1.69684E−06,
A8 = 1.21445E−07 A10 = −3.33576E−09, A12 = 4.20857E−11,
A14 = −1.53813E−16
Surface No. 15
K = 0.00000E+00, A4 = 4.81157E−05, A6 = −3.00612E−06,
A8 = 2.16050E−07 A10 = −6.05916E−09, A12 = 7.24126E−11,
A14 = −5.87135E−16
Surface No. 19
K = 0.00000E+00, A4 = −7.95455E−05, A6 = −6.59699E−07,
A8 = 2.32215E−08 A10 = 2.28186E−10, A12 = 0.00000E+00,
A14 = 0.00000E+00
Surface No. 20
K = 0.00000E+00, A4 = 7.96778E−05, A6 = −6.42253E−07,
A8 = 2.50708E−08 A10 = −2.38401E−10, A12 = 0.00000E+00,
A14 = 0.00000E+00
Surface No. 23
K = 0.00000E+00, A4 = −3.17605E−04, A6 = 1.25084E−06,
A8 = −7.26996E−08 A10 = 4.65159E−09, A12 = 0.00000E+00,
A14 = 0.00000E+00
Surface No. 24
K = 0.00000E+00, A4 = −2.05015E−04, A6 = 2.38725E−06,
A8 = −2.02005E−08 A10 = 4.17779E−09, A12 = 0.00000E+00,
A14 = 0.00000E+00
Surface No. 25
K = 0.00000E+00, A4 = −1.57596E−04, A6 = −3.16768E−05,
A8 = 1.32944E−06 A10 = −2.13742E−08, A12 = 0.00000E+00,
A14 = 0.00000E+00
Surface No. 26
K = 0.00000E+00, A4 = −4.79859E−04, A6 = −1.55977E−05,
A8 = −1.80516E−07 A10 = 1.97355E−09, A12 = 0.00000E+00,
A14 = 0.00000E+00

TABLE 15
(Various data)

| Zooming ratio | 23.27906 | | |
|---|---|---|---|
| | Wide-angle | Middle | Telephoto |
| | limit | position | limit |
| Focal length | 4.6407 | 22.3901 | 108.0301 |
| F-number | 2.85066 | 2.85030 | 2.89876 |
| Half view angle | 41.1157 | 10.1627 | 2.0238 |
| Image height | 3.3931 | 3.8920 | 3.8920 |
| Overall length | 90.4992 | 103.5042 | 127.4992 |
| of lens system | | | |
| BF | 2.7903 | 2.7693 | 2.7693 |
| d5 | 0.6000 | 25.4000 | 48.0961 |
| d12 | 34.0590 | 9.1603 | 1.7400 |
| d20 | 2.0773 | 9.1744 | 1.2545 |
| d22 | 6.3461 | 13.6567 | 31.1541 |
| d24 | 2.9859 | 1.6819 | 0.8236 |

Zoom lens unit data

| | Initial | |
|---|---|---|
| Lens unit | surface No. | Focal length |
| 1 | 1 | 72.06655 |
| 2 | 6 | −8.95876 |
| 3 | 13 | 17.95109 |
| 4 | 21 | −66.13173 |
| 5 | 23 | 19.90325 |
| 6 | 25 | −23.34038 |

### Numerical Example 6

The zoom lens system of Numerical Example 6 corresponds to Embodiment 6 shown in FIG. 16. Table 16 shows the surface data of the zoom lens system of Numerical Example 6. Table 17 shows the aspherical data. Table 18 shows the various data.

TABLE 16
(Surface data)

| Surface number | r | d | nd | vd |
|---|---|---|---|---|
| Object surface | ∞ | | | |
| 1 | 92.29080 | 1.25000 | 1.90366 | 31.3 |
| 2 | 48.22440 | 5.45730 | 1.49700 | 81.6 |
| 3 | −287.11830 | 0.15000 | | |
| 4 | 43.18150 | 4.33750 | 1.59282 | 68.6 |
| 5 | 219.91930 | Variable | | |
| 6* | −125.38600 | 0.50000 | 1.88202 | 37.2 |
| 7* | 17.01030 | 3.69790 | | |
| 8 | −50.22220 | 0.55000 | 1.80420 | 46.5 |
| 9 | 11.00000 | 6.54870 | 1.92286 | 20.9 |
| 10 | −39.00980 | 1.65180 | | |
| 11 | −13.34240 | 0.55000 | 1.80610 | 40.7 |
| 12 | −276.37120 | Variable | | |
| 13(Diaphragm) | ∞ | 1.09990 | | |
| 14* | 13.49020 | 2.74890 | 1.61035 | 57.9 |
| 15* | 492.32460 | 3.06590 | | |
| 16 | 21.73680 | 2.58890 | 1.43700 | 95.1 |
| 17 | −39.63730 | 0.50000 | 1.75520 | 27.5 |
| 18 | 14.43810 | 3.22430 | | |
| 19* | 14.26550 | 4.84180 | 1.52500 | 70.3 |
| 20* | −18.52090 | Variable | | |
| 21 | 75.64570 | 0.70000 | 1.80610 | 33.3 |
| 22 | 23.87520 | Variable | | |
| 23* | 20.44610 | 1.99990 | 1.63550 | 23.9 |
| 24* | −44.12100 | Variable | | |
| 25 | 10.93080 | 0.59990 | 1.92286 | 20.9 |
| 26 | 8.35650 | (BF) | | |
| Image surface | ∞ | | | |

TABLE 17
(Aspherical data)

Surface No. 6
K = 0.00000E+00, A4 = 8.46888E−05, A6 = −7.28555E−07,
A8 = 6.80042E−09 A10 = −4.10607E−11, A12 = 1.00053E−13,
A14 = 0.00000E+00
Surface No. 7
K = 0.00000E+00, A4 = 6.03673E−05, A6 = −6.98515E−07,
A8 = 9.80781E−09 A10 = −2.21444E−11, A12 = −7.65499E−13,
A14 = 0.00000E+00
Surface No. 14
K = 0.00000E+00, A4 = 3.05752E−06, A6 = −1.74126E−06,
A8 = 1.29713E−07 A10 = −3.63149E−09, A12 = 4.28365E−11,
A14 = −4.48940E−15
Surface No. 15
K = 0.00000E+00, A4 = 6.23523E−05, A6 = −2.67648E−06,
A8 = 1.98861E−07 A10 = −5.61538E−09, A12 = 6.50709E−11,
A14 = −6.66716E−16
Surface No. 19
K = 0.00000E+00, A4 = −8.76283E−05, A6 = 6.46989E−08,
A8 = −4.02665E−09 A10 = 3.16161E−11, A12 = 0.00000E+00,
A14 = 0.00000E+00
Surface No. 20
K = 0.00000E+00, A4 = 3.79040E−05, A6 = 1.41149E−07,
A8 = −4.39865E−09 A10 = 3.81191E−11, A12 = 0.00000E+00,
A14 = 0.00000E+00
Surface No. 23
K = 0.00000E+00, A4 = 3.52237E−06, A6 = −4.03440E−06,
A8 = 1.30838E−07 A10 = −7.09177E−10, A12 = 0.00000E+00,
A14 = 0.00000E+00
Surface No. 24
K = 0.00000E+00, A4 = 6.77811E−05, A6 = −5.11314E−06,
A8 = 1.83867E−07 A10 = −1.38931E−09, A12 = 0.00000E+00,
A14 = 0.00000E+00

TABLE 18
(Various data)

| Zooming ratio | 23.27909 | | |
|---|---|---|---|
| | Wide-angle | Middle | Telephoto |
| | limit | position | limit |
| Focal length | 4.6404 | 22.3921 | 108.0241 |
| F-number | 2.85014 | 2.85022 | 2.84965 |
| Half view angle | 41.5379 | 10.5396 | 1.9768 |
| Image height | 3.3930 | 3.8920 | 3.8920 |
| Overall length | 88.0377 | 103.5976 | 129.3882 |
| of lens system | | | |
| BF | 4.0425 | 4.0289 | 4.0363 |
| d5 | 0.6000 | 25.4000 | 47.2715 |
| d12 | 31.1428 | 7.4736 | 1.5000 |
| d20 | 1.2500 | 15.0424 | 8.7388 |
| d22 | 3.4037 | 4.7316 | 22.2940 |
| d24 | 5.5785 | 4.8873 | 3.5212 |

Zoom lens unit data

| | Initial | |
|---|---|---|
| Lens unit | surface No. | Focal length |
| 1 | 1 | 70.68901 |
| 2 | 6 | −8.51184 |
| 3 | 13 | 18.15092 |
| 4 | 21 | −43.54006 |
| 5 | 23 | 22.25295 |
| 6 | 25 | −43.29039 |

The following Table 19 shows the corresponding values to the individual conditions in the zoom lens systems of each of Numerical Examples.

TABLE 19
(Values corresponding to conditions)

| | | Numerical Example | | | | | |
|---|---|---|---|---|---|---|---|
| | Condition | 1 | 2 | 3 | 4 | 5 | 6 |
| (1) | L_{G3}/(f_{T} × tan(ω_{T})) | 5.31 | 4.11 | 5.28 | 4.46 | 4.62 | 4.36 |
| (2) | \|M_{G1}/(f_{T} × tan(ω_{T}))\| | 9.51 | 10.79 | 9.49 | 8.45 | 9.51 | 10.63 |
| (3) | \|R₂ₐ/R_{2b}\| | 8.45 | 17.13 | 4.20 | 6.86 | 6.58 | 7.37 |
| (4) | (R_{2b} − R_{2c})/(R_{2b} + R_{2c}) | 0.23 | 0.17 | −0.08 | 0.33 | 0.26 | 0.21 |
| (5) | N₃ₚ | 1.49 | 1.52 | 1.51 | 1.50 | 1.49 | 1.52 |
| (6) | \|M_{G4}/M_{G2}\| | 2.25 | 2.18 | 2.17 | 0.65 | 2.16 | 3.17 |
| (7) | f_{G1}/f_{T} | 0.67 | 0.68 | 0.67 | 0.72 | 0.67 | 0.65 |
| (8) | \|(G_{4T} − G_{4M})/ | 1.82 | 23.52 | 0.97 | 42.07 | 2.77 | 25.44 |
| | (G_{4M} − G_{4W})\| | | | | | | |
| (9) | \|M_{G5}/(f_{T} × tan(ω_{T}))\| | 0.63 | 0.51 | 0.00 | 0.90 | 0.56 | 0.53 |

The present disclosure is applicable to a digital input device, for example, such as a digital camera, a camera for a mobile terminal device such as a smart-phone, a surveillance camera in a surveillance system, a Web camera or a vehicle-mounted camera. In particular, the present disclosure is beneficially applicable to a photographing optical system where high image quality is required like in a digital camera.

As described above, embodiments have been described as examples of art in the present disclosure. Thus, the attached drawings and detailed description have been provided.

Therefore, in order to illustrate the art, not only essential elements for solving the problems but also elements that are not necessary for solving the problems may be included in elements appearing in the attached drawings or in the detailed description. Therefore, such unnecessary elements should not be immediately determined as necessary elements because of their presence in the attached drawings or in the detailed description.

Further, since the embodiments described above are merely examples of the art in the present disclosure, it is understood that various modifications, replacements, additions, omissions, and the like can be performed in the scope of the claims or in an equivalent scope thereof.

What is claimed is:

1. A zoom lens system, in order from an object side to an image side, comprising:
a first lens unit having positive optical power;
a second lens unit having negative optical power;
a third lens unit having positive optical power;
a fourth lens unit having negative optical power; and
a fifth lens unit having positive optical power, wherein
the first lens unit is composed of three or more lens elements,
in zooming from a wide-angle limit to a telephoto limit at a time of image taking, at least the first lens unit, the second lens unit, and the third lens unit move with respect to an image surface,
a focusing lens unit, which moves with respect to the image surface in focusing from an infinity in-focus condition to a close-object in-focus condition, is provided,
the focusing lens unit is composed of one lens element, and
the following conditions (1) and (7) are satisfied:
3.2<L_{G3}/(f_{T}×tan(ω_{T})) (1)
0.3<f_{G1}/f_{T}<0.9 (7)
where
L_{G3} is an optical axial thickness of the third lens unit,
f_{T} is a focal length of the zoom lens system at the telephoto limit,
ω_{T} is a half view angle at the telephoto limit, and
f_{G1} is a focal length of the first lens unit.

2. The zoom lens system as claimed in claim 1, wherein the following condition (2) is satisfied:
2.0<|M_{G1}/(f_{T}×tan(ω_{T}))|<15.0 (2)
where
M_{G1} is an amount of movement of the first lens unit in an optical axial direction in the zooming from the wide-angle limit to the telephoto limit at the time of image taking,
f_{T} is the focal length of the zoom lens system at the telephoto limit, and
ω_{T} is the half view angle at the telephoto limit.

3. The zoom lens system as claimed in claim 1, wherein
the second lens unit, in order from the object side to the image side, comprises: a first lens element having negative optical power; and a second lens element having negative optical power, and
the first lens element and the second lens element satisfy the following conditions (3) and (4):
4.1<|R₂ₐ/R_{2b}| (3)
−0.1<(R_{2b}−R_{2c})/(R_{2b}+R_{2c}) (4)
where
R₂ₐ is a radius of curvature of an object side surface of the first lens element,
R_{2b} is a radius of curvature of an image side surface of the first lens element, and
R_{2c} is a radius of curvature of an image side surface of the second lens element.

4. The zoom lens system as claimed in claim 1, wherein
the third lens unit includes at least one lens element having positive optical power, and the following condition (5) is satisfied:
N₃ₚ<1.64 (5)
where
N₃ₚ is an average of refractive indices to the d-line of the at least one lens element having positive optical power, which constitutes the third lens unit.

5. The zoom lens system as claimed in claim 1, wherein the following condition (6) is satisfied:
0.6<|M_{G4}/M_{G2}|<8.0 (6)
where
M_{G2} is an amount of movement of the second lens unit in an optical axial direction in the zooming from the wide-angle limit to the telephoto limit at the time of image taking, and
M_{G4} is an amount of movement of the fourth lens unit in an optical axial direction in the zooming from the wide-angle limit to the telephoto limit at the time of image taking.

6. The zoom lens system as claimed in claim 1, wherein the following condition (8) is satisfied:
10<|(G_{4T}−G_{4M})/(G_{4M}−G_{4W})| (8)
where
G_{4W} is a distance from an object side inter-apex of the fourth lens unit to the image surface at the wide-angle limit,
G_{4T} is a distance from the object side inter-apex of the fourth lens unit to the image surface at the telephoto limit,
G_{4M} is a distance from the object side inter-apex of the fourth lens unit to the image surface at a middle position,
the middle position is a position at which a focal length f_{M} of the zoom lens system is represented by the following expression:
f_{M}=\sqrt{(f_{W}*f_{T})},
f_{W} is a focal length of the zoom lens system at the wide-angle limit, and
f_{T} is the focal length of the zoom lens system at the telephoto limit.

7. The zoom lens system as claimed in claim 1, wherein the following condition (9) is satisfied:

|M_{G5}/(f_{T}×tan(ω_{T}))|<1.5 (9)
where
M_{G5} is an amount of movement of the fifth lens unit in an optical axial direction in the zooming from the wide-angle limit to the telephoto limit at the time of image taking,
f_{T} is the focal length of the zoom lens system at the telephoto limit, and
ω_{T} is the half view angle at the telephoto limit.

8. The zoom lens system as claimed in claim 1, wherein the second lens unit includes at least one cemented lens element.

9. The zoom lens system as claimed in claim 1, wherein at least one lens unit is fixed with respect to the image surface in the zooming from the wide-angle limit to the telephoto limit at the time of image taking.

10. An imaging device capable of outputting an optical image of an object as an electric image signal, comprising:
a zoom lens system that forms an optical image of the object; and
an image sensor that converts the optical image formed by the zoom lens system into the electric image signal, wherein
the zoom lens system is the zoom lens system as claimed in claim 1.

11. A camera for converting an optical image of an object into an electric image signal and then performing at least one of displaying and storing of the converted image signal, comprising:
an imaging device including a zoom lens system that forms an optical image of the object and an image sensor that converts the optical image formed by the zoom lens system into the electric image signal, wherein
the zoom lens system is the zoom lens system as claimed in claim 1.
